(19) United States
(12) Patent Application Publication
(10) Pub. No.: US 2026/0012794 A1
(43) Pub. Date: Jan. 8, 2026

(54) ENHANCED QUALITY OF SERVICE-LEVEL SECURITY FOR WIRELESS COMMUNICATIONS

(71) Applicant: INTEL CORPORATION, Santa Clara, CA (US)

(72) Inventors: Yi ZHANG, San Jose, CA (US); Alexandre Saso STOJANOVSKI, Paris (FR); Abhijeet KOLEKAR, Leander, TX (US); Thomas LUETZENKIRCHEN, Taufkirchen (DE)

(73) Assignee: INTEL CORPORATION, Santa Clara, CA (US)

(21) Appl. No.: 18/881,719

(22) PCT Filed: Aug. 3, 2023
(86) PCT No.: PCT/US2023/029431

§ 371 Date: Jan. 6, 2025

Related U.S. Application Data
(60) Provisional application No. 63/395,679, filed on Aug. 5, 2022.

(51) Int. Cl. H04W 12/30

(52) U.S. Cl. CPC H04W 12/30

(57) ABSTRACT

This disclosure describes systems, methods, and devices for quality of service (QOS)-level security configuration in a packet data unit (PDU) session. A device may identify a first user plane security indication received from an application function of a wireless network; identify a second user plane security indication received from the application function; generate, based on the first user plane security indication, a first security configuration for a first QoS flow of a PDU session; generate, based on the second user plane security indication, a second security configuration for a second QoS flow of the PDU session, the first security configuration different than the second security configuration; decode a first packet received, from the UE, in the first QoS flow using the first security configuration; and decode a second packet received, from the UE, in the second QoS flow using the second security configuration.

### CROSS-REFERENCE TO RELATED PATENT APPLICATION(S)

This application claims the benefit of U.S. Provisional Application No. 63/395,673, filed Aug. 5, 2022, the disclosure of which is incorporated herein by reference as if set forth in full.

### TECHNICAL FIELD

This disclosure generally relates to systems and methods for wireless communications and, more particularly, to quality of service-level security in a packet data unit (PDU) session.

### BACKGROUND

Wireless devices are becoming widely prevalent and are increasingly using wireless channels. The 3^{rd} Generation Partnership Program (3GPP) is developing one or more standards for wireless communications.

### BRIEF DESCRIPTION OF THE DRAWINGS

FIG. 1 is a network diagram illustrating an example network environment, in accordance with one or more example embodiments of the present disclosure.

FIG. 2 illustrates an example packet data unit (PDU) session with multiple quality of service (QOS) flows and QoS-level security, in accordance with one or more example embodiments of the present disclosure.

FIG. 3 illustrates an example process for establishing an application function (AF) session with a QoS, in accordance with one or more example embodiments of the present disclosure.

FIG. 4 illustrates a flow diagram of illustrative process for facilitating a PDU session with QoS-level security, in accordance with one or more example embodiments of the present disclosure.

FIG. 5. illustrates a network, in accordance with one or more example embodiments of the present disclosure.

FIG. 6 schematically illustrates a wireless network, in accordance with one or more example embodiments of the present disclosure.

FIG. 7 is a block diagram illustrating components, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless devices may operate as defined by technical standards. For cellular telecommunications, the 3^{rd} Generation Partnership Program (3GPP) define communication techniques, including for quality of service (QOS) and packet data unit (PDU) sessions. A 3GPP PDU session refers to end-to-end connectivity between a user plane function (UPF) of the network and a user equipment device (UE) through a data network. A PDU session may support one or more QoS flows, with any QoS flow using a QoS profile. All QoS flows of a PDU session currently use a same security configuration for the air interface used in the PDU session.

5G provides a PDU session level granularity on security, i.e., all QoS flows in one PDU session share the same configuration of security, e.g., whether turn on or turn off the ciphering and integrity protection on the air interface, the maximum DL/UL integrity protected data rate. Once the security configuration is set during PDU session establishment, the security configuration cannot be modified except for the maximum DL/UL integrity protected data rate.

However, the requirements for PDU session security could be different for different QoS flows even for the services running in the same PDU session, e.g., unicast live streaming session among friends may require user plane (UP) confidentiality protection while broadcast video streaming from popular channels may not require that; AR/VR-based health care industry may require both UP integrity and confidentiality protection while AR/VR based entertainment may only require UP integrity protection; online banking requires both UP integrity and confidentiality protection while other web services doesn't require that. Another example, if the user plane traffic is already encrypted end-to-end between the application client in the UE and the application server in the data network, it may not need extra security protection on the air interface. In such cases the use of the UP integrity protection and UP confidentiality protection does not bring much value, while it requires the UE and the gNB to unnecessarily waste processing resources for ciphering and deciphering, as well as for calculation of the message authentication codes on per packet basis. With the ever increasing data rates of service data flows it is expected that the avoidance of unnecessary processing for user plane security will be beneficial for both the UEs and the gNBs.

A common security configuration for all QoS flows in one PDU session is unadaptable and inflexible. Differentiated security among the users/service flows/applications in a same PDU session is desirable.

In one or more embodiments, a PDU session between a UE and a wireless network may allow for different QoS flows of the PDU session to use different security configurations for the air interface facilitating the PDU session. The application function (AF) of the network may provide a flow description (e.g., via the NEF) to the policy control function (PCF) of the network, including a User Plane Security Indication indicating whether to turn on/off the UP integrity and confidentiality protection for a specific traffic. The user plan function (UPF) of the network and the UE may identify the traffic for which the 5G network needs to turn on or turn off the ciphering and/or integrity protection with the provided service data flow filters/application detection filter and then map the identified traffic to a specified QoS flow.

In one or more embodiments, at the gNB, the QoS-level security configuration for a PDU session may involve establishing different data radio bearers (DRBs) with various User Plane Integrity protection and confidentiality protection. The QoS-level security configuration for a PDU session may enable flexible User Plane Integrity protection and confidentiality protection on air interface for different service flows/applications.

In one or more embodiments, the PCF receives the flow description with the User Plane Security Indication. The PCF may generate a PCC rule and send it to the network session management function (SMF) where packet filters are generated and security settings on RAN are determined for respective QoS flows. The UPF and UE may use the provided packet filters to accurately identify the traffic for which network needs to turn on or turn off the ciphering and/or integrity protection, and map the traffic to a specific QoS flow. Meanwhile, the gNB needs to map the QoS flow to a specific DRB, which is configured with the requested ciphering and/or integrity protection.

In one or more embodiments, when the PCF sends a PCC rule to the SMF with the user plane security indication, the SMF may formulate different QoS constructs and send them to the processing entities along the QoS Flow as follows:
SDF Template to UPF over N4 PFCP (Packet Forwarding Control Protocol) interface.
QoS Profile to gNB via AMF over the N2 interface along with “User Plane Security Indication.”
QoS Rule to UE via AMF and gNB over the N1 interface.

In one or more embodiments, the gNB/NG-RAN, upon receiving the “User Plane Security Indication” for a QoS flow, may turn off the UP integrity protection and UP confidentiality protection for the radio bearer corresponding to that QoS Flow. The User Plane Security Indication may have following granularity such as:

1) If User plane Security indication says “Integrity protection is required/preferred” then NG-RAN may enable Integrity protection but disable Confidentiality protection.

2) If User plane Security indication says “Confidentiality protection is required/preferred” then NG-RAN may enable Confidentiality protection but disable Integrity protection.

3) If User plane Security indication says “Confidentiality protection is not required and Integrity Protection is not required” then NG-RAN may disable both Confidentiality and Integrity protection.

In one or more embodiments, the QoS-level security for a PDU session may include the following changes to TS 23.501 (changes underlined):

### 5.10.3 PDU Session User Plane Security

The User Plane Security Enforcement information provides the NG-RAN with User Plane security policies for a PDU session. It indicates:
whether UP integrity protection is:
   Required: for all the traffic on the PDU Session UP integrity protection shall apply.
   Preferred: for all the traffic on the PDU Session UP integrity protection should apply.
   Not Needed: UP integrity protection shall not apply on the PDU Session.
whether UP confidentiality protection is:
   Required: for all the traffic on the PDU Session UP confidentiality protection shall apply.
   Preferred: for all the traffic on the PDU Session UP confidentiality protection should apply.
   Not Needed: UP confidentiality shall not apply on the PDU Session.

When either the UP integrity protection or the UP confidentiality protection for the PDU Session is indicated as “Required” or “Preferred”, the SMF may include a User Plane Security Indication set to “Not Needed” for specific QoS Flow(s) of that PDU Session. When the User Plane Security Indication set to “Not Needed” is set/available for a QoS Flow, the NG-RAN may turn off the UP integrity protection and UP confidentiality protection for the radio bearer corresponding to that QoS Flow.

When either the UP integrity protection or the UP confidentiality protection for the PDU Session is indicated as “Preferred” or “Not Needed”, the SMF may include a User Plane Security Indication set to “Required” for specific QoS Flow(s) of that PDU Session. When the User Plane Security Indication set to “Required” is set/available for a QoS Flow, the NG-RAN shall turn on the UP integrity protection and UP confidentiality protection for the radio bearer corresponding to that QoS Flow.

User Plane Security Enforcement information applies only over 3GPP access. Once determined at the establishment of the PDU Session the User Plane Security Enforcement information applies for the life time of the PDU Session.
NOTE 1: Applicability of UP integrity protection of UP Security Enforcement is defined in TS 33.501 and TS 38.300.

The SMF determines at PDU session establishment a User Plane Security Enforcement information for the user plane of a PDU session based on:
subscribed User Plane Security Policy which is part of SM subscription information received from UDM; and
User Plane Security Policy locally configured per (DNN, S-NSSAI) in the SMF that is used when the UDM does not provide User Plane Security Policy information.
The maximum supported data rate per UE for integrity protection for the DRBs, provided by the UE in the Integrity protection maximum data rate IE during PDU Session Establishment. The UE supporting NR as primary RAT, i.e. NG-RAN access via Standalone NR, shall set the Integrity protection maximum data rate IE for Uplink and Downlink to full rate at PDU Session Establishment as defined in TS 24.501. A UE not supporting NR as primary RAT and supporting E-UTRA connected to 5GC, shall set the Integrity protection maximum data rate IE for Uplink and Downlink to NULL at PDU Session Establishment as defined in TS 24.501.

The User Plane Security Indication is provided from AMF to PCF (via NEF) in association with a Flow description. The PCF provides the User Plane Security Indication to SMF inside the PCC rule. SMF forwards the User Plane Security Indication to NG-RAN inside the N2 SM information.

The User Plane Security Enforcement information provides the MME with User Plane integrity protection policies for the PDU session (PDN Connection). The information indicates whether UP integrity protection is:
Required: for all the traffic on the PDU Session (PDN Connection) UP integrity protection shall apply.
Preferred: for all the traffic on the PDU Session (PDN Connection) UP integrity protection should apply.
Not Needed: UP integrity protection shall not apply on the PDU Session (PDN Connection).

In turn, the MME provides per EPS bearer User Plane Security Enforcement information to the E-UTRAN. All the bearers within a PDN Connection share the same User Plane integrity protection policies.

The UE capability to support user plane integrity protection with EPS is indicated to AMF in the SI UE network capability information. If the UE supports user plane integrity protection with EPS, and the AMF supports the associated functionality, the AMF indicates this to SMF at PDU Session Establishment using NG-RAN. If the UE and AMF support user plane integrity protection with EPS, for PDU Sessions with UP integrity protection of UP Security Enforcement Information set to Required, the SMF may perform the EPS bearer ID allocation procedure as described in TS 23.502 clause 4.11.1.4. If the UE does not support user plane integrity protection with EPS or the AMF does not support the associated functionality, the SMF shall not trigger the EPS bearer ID allocation procedure in clause 4.11.1.4 of TS 23.502.

Unless the UE, the serving eNB and the MME support user plane integrity protection with EPS, the SMF+PGW-C shall reject a PDN Connection Establishment using EPS if the UP Security Enforcement Information has UP integrity protection set to Required.

The SMF+PGW-C shall (e.g. based on the received RAT Type) reject a PDN Connection Establishment using GERAN/UTRAN if the UP Security Enforcement Information has UP integrity protection set to Required.
NOTE 2: This assumes that the optional user plane integrity protection for GPRS specified in Release 13 has not been deployed.

The SMF may, based on local configuration, reject the PDU Session Establishment request depending on the value of the maximum supported data rate per UE for integrity protection.
NOTE 3: Reasons to reject a PDU Session Establishment request can e.g. be that the UP Integrity Protection is determined to be “Required” while the maximum supported data rate per UE for integrity protection is less than the expected required data rate for the DN.
NOTE 4: The operator can take care to reduce the risk of such rejections when configuring the subscribed User Plane Security Policy for a DNN. For example, the operator may apply integrity protection “Required” only in scenarios where it can be assumed that the UE maximum supported data rate per UE for integrity protection is likely to be adequate for the DN.

The User Plane Security Policy provide the same level of information than User Plane Security Enforcement information.

User Plane Security Policy from UDM takes precedence over locally configured User Plane Security Policy.

The User Plane Security Enforcement information may include the maximum supported data rate for integrity protection provided by the UE, is communicated from SMF to the NG-RAN for enforcement as part of PDU session related information. If the UP Integrity Protection is determined to be “Required” or “Preferred”, the SMF also provides the maximum supported data rate per UE for integrity protection as received in the Integrity protection maximum data rate IE. This takes place at establishment of a PDU Session or at activation of the user plane of a PDU Session. The NG-RAN rejects the establishment of UP resources for the PDU Session when it cannot fulfil User Plane Security Enforcement information with a value of Required. The NG-RAN may also take the maximum supported data rate per UE for integrity protection into account in its decision on whether to accept or reject the establishment of UP resources. In this case the SMF releases the PDU Session. The NG-RAN notifies the SMF when it cannot fulfil a User Plane Security Enforcement with a value of Preferred.
NOTE 5: For example, the NG-RAN cannot fulfil requirements in User Plane Security Enforcement information with UP integrity protection set to “Required” when it cannot negotiate UP integrity protection with the UE.

It is responsibility of the NG-RAN to enforce that the maximum UP integrity protection data rate delivered to the UE in downlink is not exceeding the maximum supported data rate for integrity protection.

It is expected that generally the UP integrity protection data rate applied by the UE in uplink will not exceed the indicated maximum supported data rate, but the UE is not required to perform strict rate enforcement.

User Plane Security Enforcement information and the maximum supported data rate per UE for integrity protection is communicated from source to target NG-RAN node at handover. If the target RAN node cannot support requirements in User Plane Security Enforcement information, the target RAN node rejects the request to setup resources for the PDU Session. In this case the PDU Session is not handed over to the target RAN node and the PDU Session is released.

If the UE or the new eNB or the MME does not indicate support of user plane integrity protection with EPS, PDU Sessions with UP integrity protection of the User Plane Security Enforcement information set to Required are not transferred to EPS as follows:
In the case of mobility without N26, the SMF+PGW-C shall reject a PDN connectivity request in EPS with handover indication if the UP integrity protection of the User Plane Security Enforcement is set to Required.
NOTE 6: As described in clause 5.17.2.3.3, the UE does not know before trying to move a given PDU Session to EPC, whether that PDU session can be transferred to EPC.
In the case of idle mode and connected mode mobility with N26 to EPS, or mobility without N26, the SMF+PGW-C ensures that the PDU session is released.

If the UE, target eNB and the target MME indicate support of User Plane Integrity Protection with EPS, PDU Sessions with UP integrity protection of the User Plane Security Enforcement information set to Required are transferred from 5GS to EPS according to existing procedures.

For the bearers of PDN Connections with UP integrity protection set to Required, at (both idle mode and connected mode) mobility (including intra-TA mobility) to an eNB that does not support User Plane Integrity Protection with EPS, the MME shall inform the SMF+PGW-C and the SMF+PGW-C ensures that the PDU session is released.

At connected mode mobility from EPS to GERAN/UTRAN or to a part of the EPS that does not support User Plane Integrity Protection, the source E-UTRAN shall ensure that EPS bearers with UP integrity protection of the User Plane Security Enforcement information set to Required are not handed over.

In the case of idle mode mobility from an MME that supports User Plane Integrity Protection, to an MME that does not support User Plane Integrity Protection, the (home) SMF+PGW-C shall trigger (e.g. based on the lack of MME UPIP capability information) the release of the bearers of PDN Connections with UP integrity protection set to Required.

At any (e.g. idle mode) mobility from EPS to GERAN/UTRAN, the (home) SMF+PGW-C shall trigger (e.g. based on the received RAT Type) the release of the bearers of PDN Connections with UP integrity protection set to Required.

PDU Sessions with UP confidentiality protection of the User Plane Security Enforcement information set to Required and UP integrity protection of the User Plane Security Enforcement information not set to Required, are allowed to be handed over to EPS regardless of how UP confidentiality protection applies in EPS.

In the case of dual connectivity, the Integrity Protection is set to “Preferred”, the Master NG-RAN node may notify the SMF when it cannot fulfil a User Plane Security Enforcement with a value of Preferred. The SMF handling of the PDU session with respect to the Integrity Protection status is up to SMF implementation decision.

In one or more embodiments, the QoS-level security in a PDU session may include the following changes to TS 23.502 (changes in underline):

4.15.6.6 Setting Up an AF Session with Required QoS Procedure

1. The AF sends a request to reserve resources for an AF session using Nnef_AFsessionWithQoS_Create request message (UE address, AF Identifier, Flow description(s) or External Application Identifier, QoS reference, QoS parameters, Alternative Service Requirements (as described in clause 6.1.3.22 of TS 23.503), DNN, S-NSSAI) to the NEF. Optionally, a period of time or a traffic volume for the requested QoS can be included in the AF request. When the Flow description(s) is included, the AF may also include a User Plane Security Indication, (see TS 23.501 clause 5.10.3). The AF may, instead of a QoS Reference, provide the following individual QoS parameters: Requested 5GS Delay (optional), Requested Priority (optional), Requested Guaranteed Bitrate, Requested Maximum Bitrate. Regardless, whether the AF request is formulated using a QOS Reference or Individual QoS paramaters, the AF may also provide the following optional QoS parameters: flow direction, Burst Size, Burst Arrival Time at UE (uplink) or UPF (downlink), Periodicity, Time domain, Survival Time. When optional Alternative Service Requirements are provided by the AF request that is formulated with the help of Individual QoS parameters, Requested Alternative QoS Parameter Set(s) as in clause 6.1.3.22 of TS 23.503 may be provided instead of a QoS Reference.

2. The NEF assigns a Transaction Reference ID to the Nnef_AFsession WithQoS_Create request. The NEF authorizes the AF request and may apply policies to control the overall amount of QoS authorized for the AF. If the authorisation is not granted, all steps (except step 5) are skipped and the NEF replies to the AF with a Result value indicating that the authorisation failed.

3. The NEF determines whether to invoke the TSCTSF or to directly contact the PCF. This determination may use the set of individual QoS parameters or Requested Alternative QOS Parameter Set(s) from the AF. The determination may also use the AF identifier.
If the NEF determines not to invoke the TSCTSF, then steps 3, 4, 5, 6, 7, 8 are executed, otherwise, steps 3a, 3b, 4a, 4b, 5, 6a, 7a, 7b, 8 are executed.
If the NEF determines to contact the PCF directly without invoking the TSCTSF, the NEF uses the UE address to discover the PCF from the BSF. The NEF interacts with the PCF by triggering a Npcf_PolicyAuthorization_Create request and provides UE address, AF Identifier, Flow description(s), the individual QoS parameters, QoS Reference, Alternative Service Requirements and User Plane Security Indication (if it was provided in step 1). Any optionally received period of time or traffic volume is also included and mapped to sponsored data connectivity information (as defined in TS 23.503).
If the AF is considered to be trusted by the operator, the AF uses the Npcf_PolicyAuthorization_Create request message to interact directly with PCF to request reserving resources for an AF session.
   3a. If the NEF determines to invoke the TSCTSF, the NEF forwards received individual QoS parameters, QoS references and Requested Alternative QoS Parameter Set(s) in the Ntsctsf_QoSandTSCAssistance_Create request message to the TSCTSF.
If the AF is considered to be trusted by the operator, the AF uses the Ntsctsf_QoSandTSCAssistance_Create request message to interact directly with TSCTSF to request reserving resources for an AF session.
A TSCTSF address may be locally configured (a single TSCTSF per DNN/S-NSSAI) in the NEF, PCF and trusted AF. Alternatively, the NEF uses the AF Identifier to determine the DNN/S-NSSAI and uses the DNN/S-NSSAI to discover the TSCTSF from the NRF.

3b. The TSCTSF determines whether it has an AF-session with a PCF for the given UE address. In this case the TSCTSF interacts with the PCF by triggering a Npcf_PolicyAuthorization_Update request and provides UE address, AF Identifier, Flow description(s), the QoS Reference, Individual QoS Parameters and the Alternative Service Requirements. Any optionally received period of time or traffic volume is also included and mapped to sponsored data connectivity information (as defined in TS 23.203).
If the TSCTSF does not have an AF-session for a given UE address, the TSCTSF discovers the PCF and TSCTSF sends the Requested PDB, the TSC Assistance Container and other received individual QoS parameters and Requested Alternative QoS Parameter Set(s) to the PCF in Npcf_PolicyAuthorization_Create request message.
If the TSCTSF receives a Requested 5GS Delay and if the TSCTSF does not have the 5GS Bridge information for the AF-session, the TSCTSF can subscribe for the 5GS Bridge information from the PCF by triggering a Npcf_PolicyAuthorization_Subscribe request. The TSCTSF calculates a Requested PDB by subtracting the UE-DS-TT Residence Time (either provided by the PCF or pre-configured at TSCTSF) from the Requested 5GS Delay. If the TSCTSF receives any of the following individual QoS parameters: flow direction, Burst Arrival Time, Periodicity, Time domain, Survival Time from the NEF, the TSCTSF determines the TSC Assistance Container and sends it together with the Requested PDB, the TSC Assistance Container and other received individual QOS parameters in the Npcf_PolicyAuthorization_Create/Update request to the PCF.

4. For requests received from the NEF in step 3, the PCF determines whether the request is authorized and notifies the NEF if the request is not authorized.
If the request is authorized, the PCF derives the required QoS parameters based on the information provided by the NEF and determines whether this QoS is allowed (according to the PCF configuration) and notifies the result to the NEF. In addition, if the Alternative Service Requirements are provided, the PCF derives the Alternative QoS parameter set(s) from the one or more QoS reference parameters or the Requested Alternative QoS Parameter Set(s) contained in the Alternative Service Requirements in the same prioritized order (as defined in clause 6.1.3.22 of TS 23.503).
If the AF is considered to be trusted by the operator, the PCF sends the Npcf_PolicyAuthorization_Create response message directly to AF.

NOTE 1: The PCF derived Alternative QoS parameter set(s) for the PCC rule are subsequently used to establish Alternative QoS Profile(s). The Alternative QoS Profile parameters provided to the NG-RAN are specified in clause 5.7.1.2a of TS 23.501.
If the PCF determines that the SMF needs updated policy information, the PCF issues a Npcf_SMPolicyControl_UpdateNotify request with updated policy information about the PDU Session as described in the PCF initiated SM Policy Association Modification procedure in clause 4.16.5.2.
If the AF is considered to be trusted by the operator, the PCF sends the Npcf_PolicyAuthorization_Update response message directly to AF.
If the request is not authorized, or the required QoS is not allowed, NEF responds to the AF in step 5 with a Result value indicating the failure cause.

4a. For requests received from the TSCTSF in step 3b, the PCF determines whether the request is authorized and notifies the TSCTSF if the request is not authorized. If the request is authorized, the PCF derives the required QoS parameters based on the information provided by the TSCTSF and determines whether this QoS is allowed (according to the PCF configuration) and notifies the result to the TSCTSF. In addition, if the Alternative Service Requirements are provided, the PCF derives the Alternative QoS parameter set(s) from the one or more QoS reference parameters, or Requested Alternative QoS Parameter Set(s) (if provided) contained in the Alternative Service Requirements and Requested PDBs corresponding to the Requested Alternative QoS Parameter Set(s) in the same prioritized order (as defined in clause 6.1.3.22 of TS 23.503).
If the PCF receives the individual QoS parameters instead of QOS Reference, the PCF sets the PDB and MDBV according to the received Requested PDB and Burst Size received from the TSCTSF. If the Requested PDB is not provided, the PCF determines the PDB that matches the QoS Reference. It also sets the GBR and MBR for the PCC rule according to requested values sent by the TSCTSF. The PCF may use the Requested Priority from the AF to determine Priority Level as defined in clause 5.7.3.3 of TS 23.501. TSCTSF specified Individual QoS Parameter values supersede default values for the 5QI.
If the PCF determines that the SMF needs updated policy information, the PCF issues a Npcf_SMPolicyControl_UpdateNotify request with updated policy information about the PDU Session as described in the PCF initiated SM Policy Association Modification procedure in clause 4.16.5.2. If the PCF receives a subscription for the 5GS Bridge information from the TSCTSF, if the PCF does not have the 5GS Bridge information for the PDU Session, the PCF uses the PCF initiated SM Policy Association Modification procedure as described in clause 4.16.5.2 to subscribe for 5GS Bridge information event from the SMF. Once the PCF has the 5GS Bridge information, the PCF notifies the TSCTSF for the 5GS Bridge information (including the UE-DS-TT Residence Time).
If the request is not authorized, or the required QoS is not allowed, TSCTSF responds to the NEF in step 4b with a Result value indicating the failure cause.

4b. The TSCTSF sends a Ntsctsf_QoSandTSCAssistance_Create response message (Transaction Reference ID, Result) to the NEF. Result indicates whether the request is granted or not.
If the AF is considered to be trusted by the operator, the TSCTSF sends the Ntsctsf_QoSandTSCAssistance_Create response message directly to AF.

5. The NEF sends a Nnef_AFsessionWithQoS_Create response message (Transaction Reference ID, Result) to the AF. Result indicates whether the request is granted or not.

6. The NEF shall send a Npcf_PolicyAuthorization_Subscribe message to the PCF to subscribe to notifications of Resource allocation status and may subscribe to other events described in clause 6.1.3.18 of TS 23.503.

6a. The TSCTSF shall send a Npcf_PolicyAuthorization_Subscribe message to the PCF to subscribe to notifications of Resource allocation status and may subscribe to other events described in clause 6.1.3.18 of TS 23.503.

7. When the event condition is met, e.g. that the establishment of the transmission resources corresponding to the QoS update succeeded or failed, the PCF sends Npcf_PolicyAuthorization_Notify message to the NEF notifying about the event.
If the AF is considered to be trusted by the operator, the PCF sends the Npcf_PolicyAuthorization_Notify message directly to AF.

7a. When the event condition is met, e.g. that the establishment of the transmission resources corresponding to the QoS update succeeded or failed, the PCF sends Npcf_PolicyAuthorization_Notify message to the TSCTSF notifying about the event.

7b. The TSCTSF sends Ntsctsf_QoSandTSCAssistance_Notify message with the event reported by the PCF to the NEF.
If the AF is considered to be trusted by the operator, the TSCTSF sends the Ntsctsf_QoSandTSCAssistance_Notify message directly to AF.

8. The NEF sends Nnef_AFsessionWithQoS_Notify message with the event reported by the PCF to the AF.
The AF may send Nnef_AFsession WithQoS_Revoke request to NEF in order to revoke the AF request. The NEF authorizes the revoke request and triggers the Ntsctsf_QoSandTSCAssistance_Delete/Unsubscribe and/or Npcf_PolicyAuthorization_Delete and the Npcf_Policy Authorization_Unsubscribe operations for the AF request.

### 5.2.5.3.2 Npcf_PolicyAuthorization_Create Service Operation

Service operation name: Npcf_PolicyAuthorization_Create

Description: Authorize the request and optionally determines and installs SM Policy

Control Data according to the information provided by the NF Consumer or provides Port Management Information Container for ports on DS-TT or NW-TT, or User plane node Management Information Container.

Inputs, Required: UE (IP or MAC) address, identification of the application session context.

Inputs, Optional: GPSI or SUPI if available, Internal Group Identifier, DNN if available, S-NSSAI if available, Media type, Media format, bandwidth requirements, sponsored data connectivity information if applicable, flow description, AF Application Identifier, AF Communication Service Identifier, AF Record Identifier, Flow status, Priority indicator, emergency indicator, ASP Identifier, resource allocation outcome, AF Application Event Identifier, a list of DNAI(s) and corresponding routing profile ID(s) or N6 traffic routing information, AF Transaction Id, Early and/or late notifications about UP path management events, temporal validity condition, spatial validity condition, Information for EAS IP Replacement in 5GC, Indication for EAS Relocation, AF indication for simultaneous connectivity over source and target PSA at edge relocation as described in clause 5.6.7 in 23.501, Background Data Transfer Reference ID, priority sharing indicator as described in clause 6.1.3.15 in TS 23.503, pre-emption control information as described in clause 6.1.3.15 in TS 23.503, Port Management Information Container and related port number, User plane node Management Information Container, TSN AF parameters provided by the TSN AF to the PCF as described in clause 6.1.3.23 of TS 23.503, Requested Alternative QoS Parameter Set(s), QoS parameter(s) to be measured, Reporting frequency, Target of reporting and optional an indication of local event notification as described in clause 6.1.3.21 of TS 23.503, individual QOS parameters as described in clause 6.1.3.22 of TS 23.503, Alternative Service Requirements (containing one or more QoS reference parameters in a prioritized order), MPS for Data Transport Service indicator as described in clause 6.1.3.11 of TS 23.503, User Plane Security Indicator (see TS 23.501 clause 5.10.3).
NOTE: When only one DNAI and corresponding routing profile ID(s) and the Indication for EAS Relocation are available, the presented DNAI is the target DNAI as defined in clause 6.3.7 of TS 23.548.
   Outputs, Required: Success or Failure (reason for failure, e.g. as defined in clauses 6.1.3.16 and clause 6.1.3.10 of TS 23.503).
   Outputs, Optional: The service information that can be accepted by the PCF.

### 5.2.6.9.2 Nnef_AFsessionWithQoS_Create Service Operation

Service operation name: Nnef_AFsessionWithQoS_Create

Description: The consumer requests the network to provide a specific QoS for an AF session.

Inputs, Required: AF Identifier, UE address (i.e. IP address or MAC address), Flow description(s) or External Application Identifier, QoS Reference.

Inputs, Optional: time period, traffic volume, Alternative Service Requirements (containing one or more QoS reference parameters in a prioritized order), QoS parameter(s) to be measured, Reporting frequency, Target of reporting and optional an indication of local event notification as described in clause 6.1.3.21 of TS 23.503, individual QoS parameters as described in clause 6.1.3.22 of TS 23.503, DNN if available, S-NSSAI if available, Alternative QoS Related parameter sets, User Plane Security Indication (see TS 23.501 clause 5.10.3).

Outputs, Required: Transaction Reference ID, result.

Output (optional): None.

In one or more embodiments, QoS-level security for a PDU session may include modifications to TS 33.501 (updates in underline):

### 6.6 UP Security Mechanisms

### 6.6.1 UP Security Policy

The SMF shall provide UP security policy for a PDU session to the ng-eNB/gNB during the PDU session establishment procedure as specified in TS 23.502.

The UP security policy shall indicate whether UP confidentiality and/or UP integrity protection shall be activated or not for all DRBs belonging to that PDU session. The UP security policy shall be used to activate UP confidentiality and/or UP integrity for all DRBs belonging to the PDU session. As per clause 5.10.3 of 23.501, the SMF may include a User Plane Security Indication for specific QoS Flow(s) of that PDU Session. When the User Plane Security Indication is available for a QoS Flow, the NG-RAN may turn off the UP integrity protection and UP confidentiality protection for the radio bearer corresponding to that QoS Flow.

The ng-eNB/gNB shall activate UP confidentiality and/or UP integrity protection per each DRB, according to the received UP security policy and User plane security indication, using RRC signalling as defined in clause 6.6.2. If the user plane security policy indicates “Required” or “Not needed”, the ng-eNB/gNB shall not overrule the UP security policy provided by the SMF. If the ng-eNB/gNB cannot activate UP confidentiality and/or UP integrity protection when the received UP security policy is “Required”, the ng-eNB/gNB shall reject establishment of UP resources for the PDU Session and indicate reject-cause to the SMF. If the received UP security policy is “Not needed”, then the establishment of the PDU Session shall proceed as described in TS 23.502. Only if the UE indicates that it supports use of integrity protection with ng-eNB, the ng-eNB can activate UP integrity protection.
NOTE 1: Local SMF can override the confidentiality option in the UP security policy received from the home SMF based on its local policy, roaming agreement and/or regulatory requirements.

At an Xn-handover from the source ng-eNB/gNB to the target ng-eNB/gNB, the source ng-eNB/gNB shall include in the HANDOVER REQUEST message, the UE's UP security policy. If the UP security policy is ‘Required’, the target ng-eNB/gNB shall reject all PDU sessions for which it cannot comply with the corresponding received UP security policy and indicate the reject-cause to the SMF. For the accepted PDU sessions, the target ng-eNB/gNB shall activate UP confidentiality and/or UP integrity protection per DRB according to the received UE's UP security policy and shall indicate that to the UE in the HANDOVER COMMAND by the source ng-eNB/gNB. Only if the UE indicates that it supports use of integrity protection with ng-eNB, the target ng-eNB can activate UP integrity protection. If the UE receives an indication in the HANDOVER COMMAND that UP integrity protection and/or UP encryption for a PDU session is enabled at the target ng-eNB/gNB, the UE shall generate or update the UP encryption key and/or UP integrity protection key and shall activate UP encryption and/or UP integrity protection for the respective PDU session.
NOTE 2: If the security policy is ‘Preferred’, it is possible to have a change in activation or deactivation of UP integrity after the handover.

Further, in the Path-Switch message, the target ng-eNB/gNB shall send the UE's UP security policy and corresponding PDU session ID received from the source ng-eNB/gNB to the SMF. The SMF shall verify that the UE's UP security policy received from the target ng-eNB/gNB is the same as the UE's UP security policy that the SMF has locally stored. If there is a mismatch, the SMF shall send its locally stored UE's UP security policy of the corresponding PDU sessions to the target ng-eNB/gNB. This UP security policy information, if included by the SMF, is delivered to the target ng-eNB/gNB in the Path-Switch Acknowledge message. The SMF shall support logging capabilities for this event and may take additional measures, such as raising an alarm.

If the target ng-eNB/gNB receives UE's UP security policy from the SMF in the Path-Switch Acknowledge message, the target ng-eNB/gNB shall update the UE's UP security policy with the received UE's UP security policy. If UE's current UP confidentiality and/or UP integrity protection activation is different from the received UE's UP security policy, then the target ng-eNB/gNB shall initiate intra-cell handover procedure which includes RRC Connection Reconfiguration procedure to reconfigure the DRBs to activate or de-activate the UP integrity/confidentiality as per the received policy from SMF.

In case of the target ng-eNB/gNB receives both UE security capability and UP security policy, then ng-eNB/gNB initiates the intra-cell handover procedure which contains selected algorithm and an NCC to the UE. New UP keys shall be derived and used at both the UE and the target ng-eNB/gNB.

At an N2-handover the SMF shall send the UE's UP security policy to the target ng-eNB/gNB via the target AMF. The target ng-eNB/gNB shall reject all PDU sessions for which it cannot comply with the corresponding received UP security policy and indicate the reject-cause to the SMF via the target AMF. For all other PDU sessions, the target ng-eNB/gNB shall activate UP confidentiality and/or UP integrity protection per DRB according to the received UE's UP security policy. Only if the UE indicates that it supports use of integrity protection with ng-eNB, the target ng-eNB can activate UP integrity protection.

At interworking-handover from EPS to 5GS, the SMF+PGW-C provides the UE's UP security policy to the target ng-eNB/gNB via the target AMF. The target ng-eNB shall determine from the UP security policy received from the AMF together with the UE indication that it supports user plane integrity protection with ng-eNB in UE EPS security capabilities (i.e. bit EIA7), whether to activate user plane integrity protection with the UE or not. The target ng-eNB/gNB shall reject all DRBs for which it cannot comply with the corresponding UP integrity protection policy in the UP security policy and indicate the reject-cause to the source MME via the target AMF. For all other DRBs, the target ng-eNB/gNB shall activate UP integrity protection per DRB according to the used UP security policy. Only if the UE indicates that it supports use of user plane integrity protection with ng-eNB, the target ng-eNB can activate UP integrity protection. If the target AMF detects in a Registration procedure following interworking-handover from EPS to 5GS, and becomes aware of that there is a mismatch between the UE EPS security capabilities received from the source MME and the one received from the UE, and that the target ng-eNB may not have the UE capability indicating UP IP support in UE EPS security capabilities, then the AMF shall send an N2 CONTEXT MODIFICATION REQUEST message to inform the target ng-eNB about the correct UE EPS security capabilities and target ng-eNB shall take the new UE EPS security capabilities into account.

In one or more embodiments, the QoS-level security for a PDU session may include modifications to TS 38.413 (modifications in underline):

‘Security Indication’ is applied per QoS flow instead of per PDU session during the PDU session resource setup procedure and PDU session resource modification procedure.

### 9.3.4.1 PDU Session Resource Setup Request Transfer.

This IE is transparent to the AMF and shown below in Table 1.

TABLE 1
PDU Session Resource Setup Request Transfer

| | | | IE type and | Semantics | | Assigned |
|---|---|---|---|---|---|---|
| IE/Group Name | Presence | Range | reference | description | Criticality | Criticality |
| PDU Session | O | | 9.3.1.102 | This IE shall be | YES | reject |
| Aggregate | | | | present when at | | |
| Maximum Bit | | | | least one Non-GBR | | |
| Rate | | | | QoS flow is being | | |
| | | | | setup and is | | |
| | | | | ignored otherwise. | | |
| UL NG-U UP | M | | UP Transport | UPF endpoint of | YES | reject |
| TNL | | | Layer | the NG-U transport | | |
| Information | | | Information | bearer, for delivery | | |
| | | | 9.3.2.2 | of UL PDUs. | | |
| Additional UL | O | | UP Transport | UPF endpoint of | YES | reject |
| NG-U UP | | | Layer | the additional NG- | | |
| TNL | | | Information | U transport | | |
| Information | | | List | bcarcr(s), for | | |
| | | | 9.3.2.12 | delivery of UL | | |
| | | | | PDUs for split | | |
| | | | | PDU session. | | |
| Data | O | | 9.3.1.63 | This IE may be | YES | rcject |
| Forwarding | | | | present in case of | | |
| Not Possible | | | | HANDOVER | | |
| | | | | REQUEST | | |
| | | | | message and is | | |
| | | | | ignored otherwise. | | |
| PDU Session | M | | 9.3.1.52 | | YES | reject |
| Type | | | | | | |
| Security | O | | 9.3.1.27 | | YES | reject |
| Indication | | | | | | |
| Network | O | | 9.3.1.113 | This IE is ignored | YES | reject |
| Instance | | | | if the Common | | |
| | | | | Network Instance | | |
| | | | | IE is included. | | |
| QoS Flow | | 1 | | | YES | reject |
| Setup Request | | | | | | |
| List | | | | | | |
| >QoS Flow | | 1 . . . <maxnoofQoSFlows> | | | — | |
| Setup | | | | | | |
| Request Item | | | | | | |
| >>QoS | M | | 9.3.1.51 | | — | |
| Flow | | | | | | |
| Identifier | | | | | | |
| >>QoS | M | | 9.3.1.12 | | — | |
| Flow Level | | | | | | |
| QoS | | | | | | |
| Parameters | | | | | | |
| >>E-RAB | O | | 9.3.2.3 | | — | |
| ID | | | | | | |
| >>TSC | O | | 9.3.1.130 | This IE may be | YES | ignore |
| Traffic | | | | present in case of | | |
| Characteristics | | | | GBR QoS flows | | |
| | | | | and is ignored | | |
| | | | | otherwise. | | |
| >>Redundant | O | | 9.3.1.134 | This IE indicates | YES | ignore |
| QoS Flow | | | | whether this QoS | | |
| Indicator | | | | flow is requested | | |
| | | | | for the redundant | | |
| | | | | transmission. | | |
| >>Per-QoS | O | | 9.3.1.27 | | YES | reject |
| Flow User | | | | | | |
| Plane | | | | | | |
| Security | | | | | | |
| Indication | | | | | | |
| Common | O | | 9.3.1.120 | | YES | ignore |
| Network | | | | | | |
| Instance | | | | | | |
| Direct | O | | 9.3.1.64 | This IE may be | YES | ignore |
| Forwarding | | | | present in case of | | |
| Path | | | | inter-system | | |
| Availability | | | | handover and intra- | | |
| | | | | system handover. | | |
| Redundant UL | O | | UP Transport | UPF endpoint of | YES | ignore |
| NG-U UP | | | Layer | the NG-U transport | | |
| TNL | | | Information | bearer, for delivery | | |
| Information | | | 9.3.2.2 | of UL PDUs for | | |
| | | | | the redundant | | |
| | | | | transmission. | | |
| Additional | O | | UP Transport | UPF endpoint of | YES | ignore |
| Redundant UL | | | Layer | the additional NG- | | |
| NG-U UP | | | Information | U transport | | |
| TNL | | | List | bearer(s), for | | |
| Information | | | 9.3.2.12 | delivery of | | |
| | | | | redundant UL | | |
| | | | | PDUs for split | | |
| | | | | PDU session. | | |
| Redundant | O | | Common | | YES | ignore |
| Common | | | Network | | | |
| Network | | | Instance | | | |
| Instance | | | 9.3.1.120 | | | |
| Redundant | O | | 9.3.1.136 | | YES | ignore |
| PDU Session | | | | | | |
| Information | | | | | | |
| MBS Session | O | | 9.3.1.211 | | YES | ignore |
| Setup Request | | | | | | |
| List | | | | | | |

### 9.3.4.3 PDU Session Resource Modify Request Transfer

This IE is transparent to the AMF and is shown in Table 2 below.

TABLE 2
PDU Session Resource Modify Request Transfer

| | | | IE type and | Semantics | | Assigned |
|---|---|---|---|---|---|---|
| IE/Group Name | Presence | Range | reference | description | Criticality | Criticality |
| PDU Session | O | | 9.3.1.102 | | YES | reject |
| Aggregate | | | | | | |
| Maximum Bit | | | | | | |
| Rate | | | | | | |
| UL NG-U UP | | 0 . . . 1 | | | YES | reject |
| TNL Modify List | | | | | | |
| >UL NG-U UP TNL Modify Item | | 1 . . . <maxnoofMultiConnectivity> | | This IE(s) are | — | |
| | | | | included only for | | |
| | | | | modification of | | |
| | | | | an existing | | |
| | | | | tunnel. | | |
| >>UL NG-U | M | | UP Transport | UPF endpoint of | — | |
| UP TNL | | | Layer | the NG-U | | |
| Information | | | Information | transport bearer, | | |
| | | | 9.3.2.2 | for delivery of | | |
| | | | | UL PDUs. | | |
| >>DL NG-U | M | | UP Transport | Identifies the | — | |
| UP TNL | | | Layer | NG-U transport | | |
| Information | | | Information | bearer at the NG- | | |
| | | | 9.3.2.2 | RAN node. | | |
| >>Redundant | O | | UP Transport | UPF endpoint of | YES | ignore |
| UL NG-U UP | | | Layer | the NG-U | | |
| TNL | | | Information | transport bearer, | | |
| Information | | | 9.3.2.2 | for delivery of | | |
| | | | | UL PDUs for the | | |
| | | | | redundant | | |
| | | | | transmission. | | |
| >>Redundant | O | | UP Transport | Identifies the | YES | ignore |
| DL NG-U UP | | | Layer | NG-U transport | | |
| TNL | | | Information | bearer at the NG- | | |
| Information | | | 9.3.2.2 | RAN node for | | |
| | | | | the redundant | | |
| | | | | transmission. | | |
| Network Instance | O | | 9.3.1.113 | This IE is | YES | reject |
| | | | | ignored if the | | |
| | | | | Common | | |
| | | | | Network | | |
| | | | | Instance IE is | | |
| | | | | included. | | |
| QoS Flow Add or | | 0 . . . 1 | | | YES | reject |
| Modify Request | | | | | | |
| List | | | | | | |
| >QoS Flow Add | | 1 . . . <maxnoofQoSFlows> | | | — | |
| or Modify | | | | | | |
| Request Item | | | | | | |
| >>QoS Flow | M | | 9.3.1.51 | | — | |
| Identifier | | | | | | |
| >>QoS Flow | O | | 9.3.1.12 | | — | |
| Level QoS | | | | | | |
| Parameters | | | | | | |
| >>E-RAB ID | O | | 9.3.2.3 | | — | |
| >>TSC Traffic | O | | 9.3.1.130 | This IE may be | YES | ignore |
| Characteristics | | | | present in case of | | |
| | | | | GBR QoS flows | | |
| | | | | and is ignored | | |
| | | | | otherwise. | | |
| >>Redundant | O | | 9.3.1.134 | This IE indicates | YES | ignore |
| QoS Flow | | | | whether this QoS | | |
| Indicator | | | | flow is requested | | |
| | | | | for the redundant | | |
| | | | | transmission. | | |
| >>Per-QoS | O | | 9.3.1.27 | | YES | ignore |
| Flow User | | | | | | |
| Plane Security | | | | | | |
| Indication | | | | | | |
| QoS Flow to | O | | QoS Flow | | YES | reject |
| Release List | | | List with | | | |
| | | | Cause | | | |
| | | | 9.3.1.13 | | | |
| Additional UL | O | | UP Transport | UPF endpoint of | YES | reject |
| NG-U UP TNL | | | Layer | the additional | | |
| Information | | | Information | NG-U transport | | |
| | | | List | bearer(s) | | |
| | | | 9.3.2.12 | proposed for | | |
| | | | | delivery of UL | | |
| | | | | PDUs for split | | |
| | | | | PDU session. | | |
| Common | O | | 9.3.1.120 | | YES | ignore |
| Network Instance | | | | | | |
| Additional | O | | UP Transport | UPF endpoint of | YES | ignore |
| Redundant UL | | | Layer | the additional | | |
| NG-U UP TNL | | | Information | NG-U transport | | |
| Information | | | List | bearer(s) | | |
| | | | 9.3.2.12 | proposed for | | |
| | | | | delivery of | | |
| | | | | redundant UL | | |
| | | | | PDUs for split | | |
| | | | | PDU session. | | |
| Redundant | O | | Common | | YES | ignore |
| Common | | | Network | | | |
| Network Instance | | | Instance | | | |
| | | | 9.3.1.120 | | | |
| Redundant UL | O | | UP Transport | UPF endpoint of | YES | ignore |
| NG-U UP TNL | | | Layer | the NG-U | | |
| Information | | | Information | transport bearer, | | |
| | | | 9.3.2.2 | for delivery of | | |
| | | | | UL PDUs for the | | |
| | | | | redundant | | |
| | | | | transmission of | | |
| | | | | the Redundant | | |
| | | | | QoS Flow(s). | | |
| Security | O | 9.3.1.27 | | | YES | ignore |
| Indication | | | | | | |
| MBS Session | O | 9.3.1.212 | | | YES | ignore |
| Setup or Modify | | | | | | |
| Request List | | | | | | |
| MBS Session To | O | 9.3.1.215 | | | YES | ignore |
| Release List | | | | | | |

### 8.2.3 PDU Session Resource Modify

If the Security Indication IE is included in the PDU Session Resource Modify Request Transfer IE, the NG-RAN node shall, if supported, only update the maximum integrity protected data rate uplink and/or the maximum integrity protected data rate downlink, and take them into account as defined in the PDU Session Resource Setup procedure. If the Per-Qos Flow User Plane Security Indication IE is included, the NG-RAN node shall, if supported, update the confidentiality and/or integrity protection configuration for the specific QoS flow.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

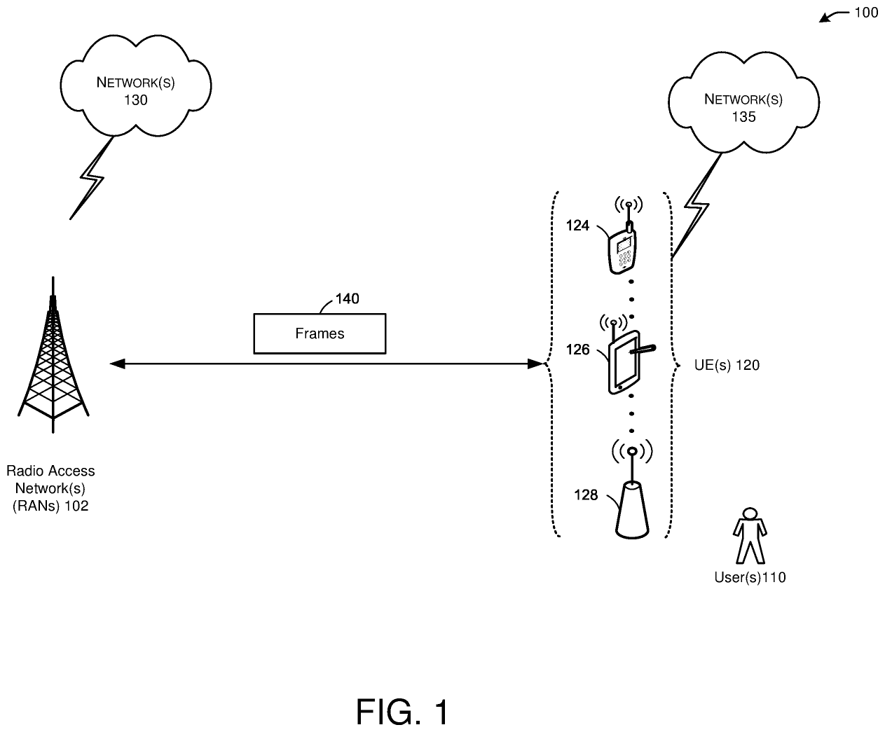

FIG. 1 is a network diagram illustrating an example network environment 100, in accordance with one or more example embodiments of the present disclosure.

Wireless network 100 may include one or more UEs 120 and one or more RANs 102 (e.g., gNBs), which may communicate in accordance with 3GPP communication standards. The UE(s) 120 may be mobile devices that are non-stationary (e.g., not having fixed locations) or may be stationary devices.

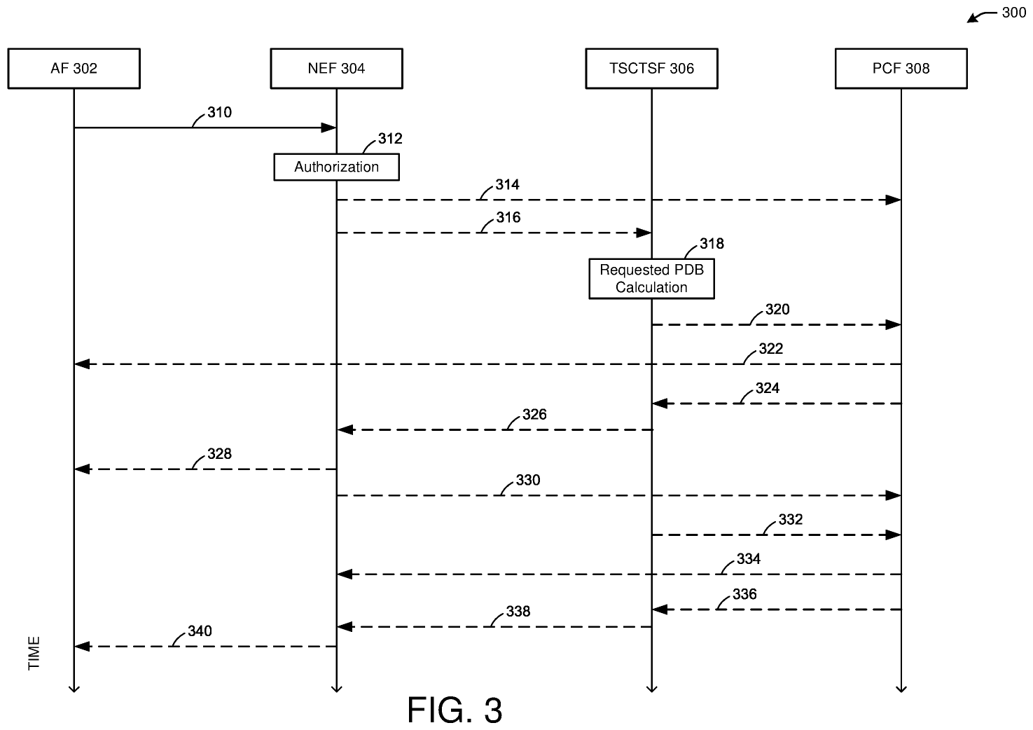

In some embodiments, the UEs 120 and the RANs 102 may include one or more computer systems similar to that of FIGS. 3-5.

One or more illustrative UE(s) 120 and/or RAN(s) 102 may be operable by one or more user(s) 110. A UE may take on multiple distinct characteristics, each of which shape its function. For example, a single addressable unit might simultaneously be a portable UE, a quality-of-service (QOS) UE, a dependent UE, and a hidden UE. The UE(s) 120 (e.g., 124, 126, or 128) and/or RAN(s) 102 may include any suitable processor-driven device including, but not limited to, a mobile device or a non-mobile, e.g., a static device. For example, UE(s) 120 may include, a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

Any of the UE(s) 120 (e.g., UEs 124, 126, 128), and UE(s) 120 may be configured to communicate with each other via one or more communications networks 130 and/or 135 wirelessly or wired. The UE(s) 120 may also communicate peer-to-peer or directly with each other with or without the RAN(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, cellular networks. In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the UE(s) 120 (e.g., UE 124, 126, 128) and RAN(s) 102 may include one or more communications antennas. The one or more communications antennas may be any suitable type of antennas corresponding to the communications protocols used by the UE(s) 120 (e.g., UEs 124, 126 and 128), and RAN(s) 102. Some non-limiting examples of suitable communications antennas include cellular antennas, 3GPP family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the UEs 120 and/or RAN(s) 102.

Any of the UE(s) 120 (e.g., UE 124, 126, 128), and RAN(s) 102 may be configured to perform directional transmission and/or directional reception in conjunction with wirelessly communicating in a wireless network. Any of the UE(s) 120 (e.g., UE 124, 126, 128), and RAN(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the UE(s) 120 (e.g., UE 124, 126, 128), and RAN(s) 102 may be configured to perform any given directional transmission towards one or more defined transmit sectors. Any of the UE(s) 120 (e.g., UE 124, 126, 128), and RAN(s) 102 may be configured to perform any given directional reception from one or more defined receive sectors.

MIMO beamforming in a wireless network may be accomplished using RF beamforming and/or digital beamforming. In some embodiments, in performing a given MIMO transmission, UE 120 and/or RAN(s) 102 may be configured to use all or a subset of its one or more communications antennas to perform MIMO beamforming.

Any of the UE 120 (e.g., UE 124, 126, 128), and RAN(s) 102 may include any suitable radio and/or transceiver for transmitting and/or receiving radio frequency (RF) signals in the bandwidth and/or channels corresponding to the communications protocols utilized by any of the UE(s) 120 and RAN(s) 102 to communicate with each other. The radio components may include hardware and/or software to modulate and/or demodulate communications signals according to pre-established transmission protocols. The radio components may further have hardware and/or software instructions to communicate via one or more 3GPP protocols and using 3GPP bandwidths. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one or more embodiments, and with reference to FIG. 1, one or more of the UEs 120 may exchange frames 140 with the RANs 102. The frames 140 may include frames of multiple QoS flows for a PDU session, and any security configuration information for the PDU session.

It is understood that the above descriptions are for purposes of illustration and are not meant to be limiting.

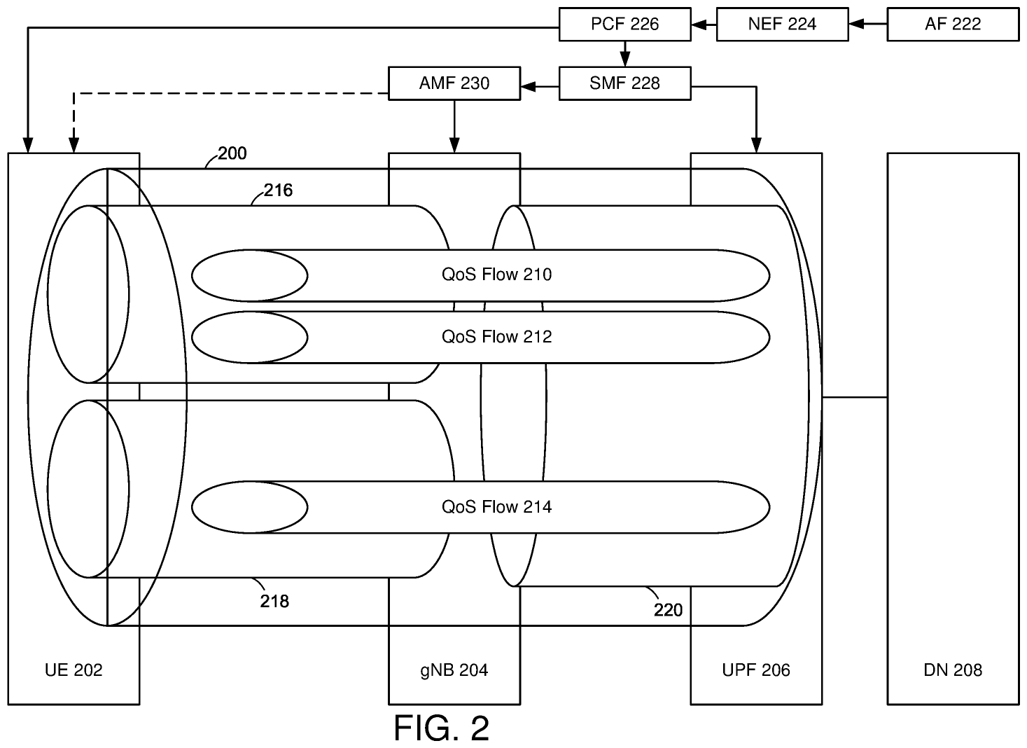

FIG. 2 illustrates an example PDU session 200 with multiple QoS flows and QoS-level security, in accordance with one or more example embodiments of the present disclosure.

Referring to FIG. 2, the PDU session 200 may between a UE 202 and a network including a gNB 204, a UPF 206, and a DN 208. The PDU session 200 may include a QoS flow 210, a QoS flow 212, a QoS flow 214, and/or any number of QoS flows. The QoS flow 210 and the QoS flow 212 may use a DRB 216 configured without a cipher and/or an integrity protocol for its air interface security configuration. The QoS flow 214 may use a DRB 218 configured with a cypher and/or with an integrity protocol for its air interface security configuration. The QoS flows of the PDU session 200 may use a GTP-U tunnel 220 between the gNB 204 and the UPF 206.

Still referring to FIG. 2, an AF 222 of the network may provide, via a NEF 224 of the network, a traffic descriptor with a user plane security indication to a PCF 226 of the network. The user plane security indication may indicate for an identified QoS flow of the PDU session 200 whether to turn on/off the cypher and/or integrity protocol. The PCF 226 may generate and provide a PCC rule for the user plane security indication to a SMF 228 of the network. The SMF 228 may forward the rule to an AMF 230 of the network, which may provide the rule to the UE 202, the gNB 204, and/or the UPF 206 to apply the rule in the PDU session 200. The PCF 226 may establish with the UE 202, UE policy association establishment/UE policy association modification procedures. The AMF 230 may indicate to the UE 202 a packet filter along with the QFI for the rule, and may indicate to the gNB 204 a per-QFI cipher and integrity protocol configuration (e.g., indicating whether they are on or off). The SMF 228 may provide to the UPF 206 packet detection information (e.g., packet filters) along with QFI.

When either the UP integrity protection or the UP confidentiality protection for the PDU session 200 is indicated as “Required” or “Preferred”, the SMF 228 may include a User Plane Security Indication set to “Not Needed” for a specific QoS Flow(s) of the PDU session 200. When the User Plane Security Indication set to “Not Needed” is set/available for a QoS flow, the gNB 204 may turn off the UP integrity protection and UP confidentiality protection for the radio bearer corresponding to that QoS flow.

When either the UP integrity protection or the UP confidentiality protection for the PDU session 200 is indicated as “Preferred” or “Not Needed”, the SMF 228 may include a User Plane Security Indication set to “Required” for specific QoS flow(s) of the PDU session 200. When the User Plane Security Indication set to “Required” is set/available for a QoS flow, the gNB 204 may turn on the UP integrity protection and UP confidentiality protection for the radio bearer corresponding to that QoS flow.

The User Plane Security Indication is provided from the AF 222 to the PCF 226 (via the NEF 224) in association with a QoS flow description. The PCF 226 provides the User Plane Security Indication to the SMF 228 inside the PCC rule. The SMF 228 forwards the User Plane Security Indication to the gNB 204 inside the N2 SM information.

In one or more embodiments, the SMF 228 may include a User Plane Security Indication for specific QoS Flow(s) of the PDU Session. When the User Plane Security Indication is available for a QoS Flow, the gNB 204 may turn off the UP integrity protection and UP confidentiality protection for the radio bearer corresponding to that QoS Flow.

FIG. 3 illustrates an example process 300 for establishing an AF session with a QoS, in accordance with one or more example embodiments of the present disclosure.

Referring to FIG. 3, the process 300 may include an AF 302 (e.g., representing the AF 222 of FIG. 2), a NEF 304 (e.g., representing the NEF 224 of FIG. 2), a TSCTSF 306 (time sensitive communication and time synchronization function), and a PCF 308 (e.g., representing the PCF 226 of FIG. 2. The AF 302 may send a Nnef_AFsessionWithQoS_create request message 310 to the NEF 304 (e.g., including UE address, AF Identifier, Flow description(s) or External Application Identifier, QoS reference, QoS parameters, Alternative Service Requirements (as described in clause 6.1.3.22 of TS 23.503), DNN, S-NSSAI), which may authorize 312 the request and may apply policies to control the overall amount of QoS authorized for the AF 302. The NEF 304 may assign a transaction reference ID to the Nnef_AFsessionWithQoS_create request message 310. Optionally, the NEF 304 may send a Npcf_PolicyAuthorization_Create request 314 to the PCF 308 to provide the UE address, AF identifier, QoS flow description(s), the individual QoS parameters, QoS reference, Alternative Service Requirements and User Plane Security Indication. The NEF 304 optionally may forward receive individual QoS parameters, QoS references and requested alternative QoS parameter set(s) in a Ntsctsf_QoSandTSCAssistance_Create request message 316 to the TSCTSF 306. If the AF 302 is considered to be trusted by the operator, the AF 302 uses the Ntsctsf_QoSandTSCAssistance_Create request message 316 to interact directly with TSCTSF 306 to request reserving resources for an AF session (e.g., the PDU session 200).

Still referring to FIG. 3, the TSCTSF 306 may perform a requested PDB calculation 318. The TSCTSF 306 determines whether it has an AF-session with a PCF 308 for the given UE address. In this case the TSCTSF 306 interacts with the PCF 308 by triggering a Npcf_PolicyAuthorization_Update request 320 and provides the UE address, AF Identifier, QoS flow description(s), the QoS Reference, Individual QoS Parameters and the Alternative Service Requirements. Any optionally received period of time or traffic volume is also included and mapped to sponsored data connectivity information (as defined in TS 23.203). The PCF 308 determines whether the request is authorized and notifies the NEF if the request is not authorized. If the AF 302 is considered to be trusted by the operator, the PCF 308 sends the Npcf_PolicyAuthorization_Create response message 322 directly to the AF 302. For requests received from the TSCTSF 306, the PCF 308 determines whether the request is authorized and notifies 324 the TSCTSF 306 if the request is not authorized. The TSCTSF 306 sends a Ntsctsf_QoSandTSCAssistance_Create response message 326 (Transaction Reference ID, Result) to the NEF 304, and the Result indicates whether the request is granted or not.

Still referring to FIG. 3, the NEF 304 sends a Nnef_AFsessionWithQoS_Create response message 328 (Transaction Reference ID, Result) to the AF 320, and the Result indicates whether the request is granted or not. The NEF 304 may send a Npcf_PolicyAuthorization_Subscribe message 330 to the PCF 308 to subscribe to notifications of Resource allocation status and may subscribe to other events described in clause 6.1.3.18 of TS 23.503. The TSCTSF 306 may send a Npcf_PolicyAuthorization_Subscribe message 332 to the PCF 308 to subscribe to notifications of Resource allocation status and may subscribe to other events described in clause 6.1.3.18 of TS 23.503. When the event condition is met, e.g. that the establishment of the transmission resources corresponding to the QoS update succeeded or failed, the PCF 308 sends a Npcf_PolicyAuthorization_Notify message 334 to the NEF 304 notifying about the event. When the event condition is met, e.g. that the establishment of the transmission resources corresponding to the QoS update succeeded or failed, the PCF 308 may send a Npcf_PolicyAuthorization_Notify message 336 to the TSCTSF 306 notifying about the event. The TSCTSF 306 may a send Ntsctsf_QoSandTSCAssistance_Notify message 338 with the event reported by the PCF 308 to the NEF 304. The NEF 304 may send a Nnef_AFsessionWithQoS_Notify message 340 with the event reported by the PCF 308 to the AF 302.

In one or more embodiments, when the Flow description(s) is included in the Nnef_AFsessionWithQoS_create request message 310, the AF 302 may also include a User Plane Security Indication, (see TS 23.501 clause 5.10.3).

In one or more embodiments, the Npcf_PolicyAuthorization_Create response message 322 may include the user plane security indicator.

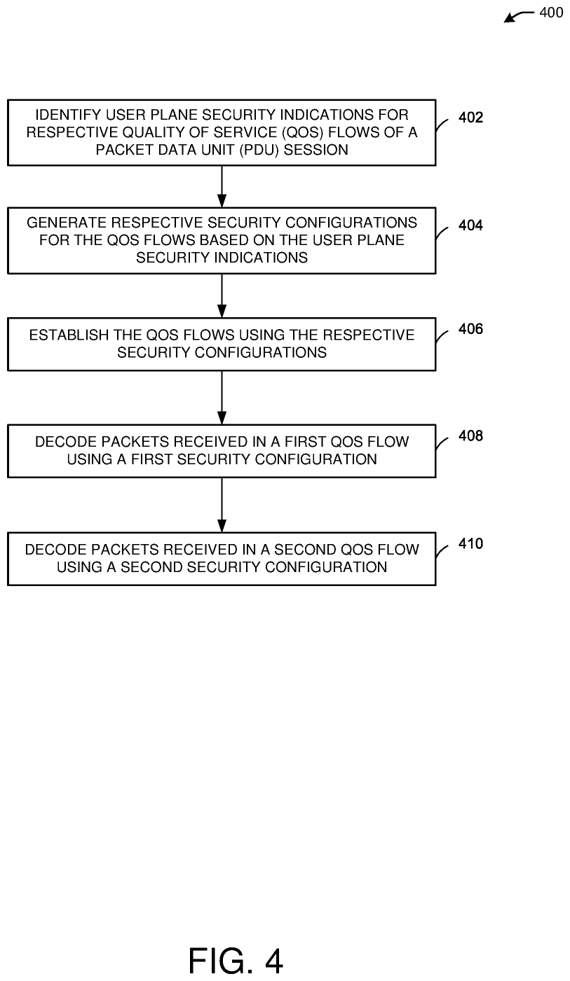

FIG. 4 illustrates a flow diagram of illustrative process 400 for facilitating a PDU session with QoS-level security, in accordance with one or more example embodiments of the present disclosure.

At block 402, a device (or system, e.g., the wireless network including the gNB 204, the UPF 206, the DN 208, the AF 222, the NEF 224, the PCF 226, the SMF 228, and the AMF 230 of FIG. 2) may identify user plane security indications for respective QoS flows of a PDU session. For example, an AF of the wireless network may provide the user plane security indications. Any of the user plane security indications may include a description of a QoS flow.

At block 404, the device may generate respective security configurations for the QoS flows based on the user plane security indications. For example, the PCF may generate a rule for any respective user plane security indication. An AMF may generate the security configuration for the rule, which may be provided to a gNB/RAN of the network and/or to a UE of the PDU session.

At block 406, the device may establish the QoS flows using the respective security configurations. The gNB/RAN may establish the QoS flows to maintain separate QoS flows for the PDU session, with the QoS flows using different respective security configurations.

At block 408, the device may decode packets received in a first QoS flow using a first security configuration.

At block 410, the device may decode packets received in a second QoS flow using a second security configuration.

The examples herein are not meant to be limiting.

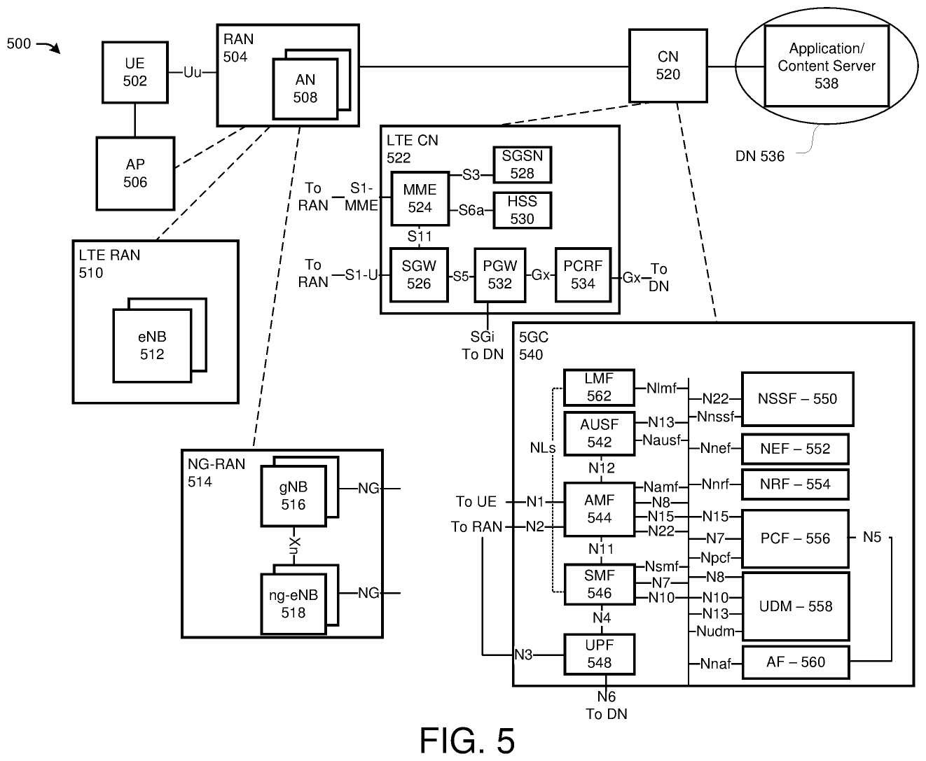

FIG. 5 illustrates a network 500 in accordance with various embodiments. The network 500 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 500 may include a UE 502, which may include any mobile or non-mobile computing device designed to communicate with a RAN 504 via an over-the-air connection. The UE 502 may be communicatively coupled with the RAN 504 by a Uu interface. The UE 502 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 500 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 502 may additionally communicate with an AP 506 via an over-the-air connection. The AP 506 may manage a WLAN connection, which may serve to offload some/all network traffic from the RAN 504. The connection between the UE 502 and the AP 506 may be consistent with any IEEE 802.11 protocol, wherein the AP 506 could be a wireless fidelity (Wi-Fi®) router. In some embodiments, the UE 502, RAN 504, and AP 506 may utilize cellular-WLAN aggregation (for example, LWA/LWIP). Cellular-WLAN aggregation may involve the UE 502 being configured by the RAN 504 to utilize both cellular radio resources and WLAN resources.

The RAN 504 may include one or more access nodes, for example, AN 508. AN 508 may terminate air-interface protocols for the UE 502 by providing access stratum protocols including RRC, PDCP, RLC, MAC, and L1 protocols. In this manner, the AN 508 may enable data/voice connectivity between CN 520 and the UE 502. In some embodiments, the AN 508 may be implemented in a discrete device or as one or more software entities running on server computers as part of, for example, a virtual network, which may be referred to as a CRAN or virtual baseband unit pool. The AN 508 be referred to as a BS, gNB, RAN node, eNB, ng-eNB, NodeB, RSU, TRxP, TRP, etc. The AN 508 may be a macrocell base station or a low power base station for providing femtocells, picocells or other like cells having smaller coverage areas, smaller user capacity, or higher bandwidth compared to macrocells.

In embodiments in which the RAN 504 includes a plurality of ANs, they may be coupled with one another via an X2 interface (if the RAN 504 is an LTE RAN) or an Xn interface (if the RAN 504 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 504 may each manage one or more cells, cell groups, component carriers, etc. to provide the UE 502 with an air interface for network access. The UE 502 may be simultaneously connected with a plurality of cells provided by the same or different ANs of the RAN 504. For example, the UE 502 and RAN 504 may use carrier aggregation to allow the UE 502 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 504 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 502 or AN 508 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 504 may be an LTE RAN 510 with eNBs, for example, eNB 512. The LTE RAN 510 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 504 may be an NG-RAN 514 with gNBs, for example, gNB 516, or ng-eNBs, for example, ng-eNB 518. The gNB 516 may connect with 5G-enabled UEs using a 5G NR interface. The gNB 516 may connect with a 5G core through an NG interface, which may include an N2 interface or an N3 interface. The ng-eNB 518 may also connect with the 5G core through an NG interface, but may connect with a UE via an LTE air interface. The gNB 516 and the ng-eNB 518 may connect with each other over an Xn interface. In some embodiments, the NG interface may be split into two parts, an NG user plane (NG-U) interface, which carries traffic data between the nodes of the NG-RAN 514 and a UPF 548 (e.g., N3 interface), and an NG control plane (NG-C) interface, which is a signaling interface between the nodes of the NG-RAN 514 and an AMF 544 (e.g., N2 interface).

The NG-RAN 514 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 502 can be configured with multiple BWPs where each BWP configuration has a different SCS. When a BWP change is indicated to the UE 502, the SCS of the transmission is changed as well. Another use case example of BWP is related to power saving. In particular, multiple BWPs can be configured for the UE 502 with different amount of frequency resources (for example, PRBs) to support data transmission under different traffic loading scenarios. A BWP containing a smaller number of PRBs can be used for data transmission with small traffic load while allowing power saving at the UE 502 and in some cases at the gNB 516. A BWP containing a larger number of PRBs can be used for scenarios with higher traffic load.

The RAN 504 is communicatively coupled to CN 520 that includes network elements to provide various functions to support data and telecommunications services to customers/subscribers (for example, users of UE 502). The components of the CN 520 may be implemented in one physical node or separate physical nodes. In some embodiments, NFV may be utilized to virtualize any or all of the functions provided by the network elements of the CN 520 onto physical compute/storage resources in servers, switches, etc. A logical instantiation of the CN 520 may be referred to as a network slice, and a logical instantiation of a portion of the CN 520 may be referred to as a network sub-slice.

In some embodiments, the CN 520 may be an LTE CN 522, which may also be referred to as an EPC. The LTE CN 522 may include MME 524, SGW 526, SGSN 528, HSS 530, PGW 532, and PCRF 534 coupled with one another over interfaces (or “reference points”) as shown. Functions of the elements of the LTE CN 522 may be briefly introduced as follows.

The MME 524 may implement mobility management functions to track a current location of the UE 502 to facilitate paging, bearer activation/deactivation, handovers, gateway selection, authentication, etc.

The SGW 526 may terminate an SI interface toward the RAN and route data packets between the RAN and the LTE CN 522. The SGW 526 may be a local mobility anchor point for inter-RAN node handovers and also may provide an anchor for inter-3GPP mobility. Other responsibilities may include lawful intercept, charging, and some policy enforcement.

The SGSN 528 may track a location of the UE 502 and perform security functions and access control. In addition, the SGSN 528 may perform inter-EPC node signaling for mobility between different RAT networks; PDN and S-GW selection as specified by MME 524; MME selection for handovers; etc. The S3 reference point between the MME 524 and the SGSN 528 may enable user and bearer information exchange for inter-3GPP access network mobility in idle/active states.

The HSS 530 may include a database for network users, including subscription-related information to support the network entities' handling of communication sessions. The HSS 530 can provide support for routing/roaming, authentication, authorization, naming/addressing resolution, location dependencies, etc. An S6a reference point between the HSS 530 and the MME 524 may enable transfer of subscription and authentication data for authenticating/authorizing user access to the LTE CN 520.

The PGW 532 may terminate an SGi interface toward a data network (DN) 536 that may include an application/content server 538. The PGW 532 may route data packets between the LTE CN 522 and the data network 536. The PGW 532 may be coupled with the SGW 526 by an S5 reference point to facilitate user plane tunneling and tunnel management. The PGW 532 may further include a node for policy enforcement and charging data collection (for example, PCEF). Additionally, the SGi reference point between the PGW 532 and the data network 536 may be an operator external public, a private PDN, or an intra-operator packet data network, for example, for provision of IMS services. The PGW 532 may be coupled with a PCRF 534 via a Gx reference point.

The PCRF 534 is the policy and charging control element of the LTE CN 522. The PCRF 534 may be communicatively coupled to the app/content server 538 to determine appropriate QoS and charging parameters for service flows. The PCRF 532 may provision associated rules into a PCEF (via Gx reference point) with appropriate TFT and QCI.

In some embodiments, the CN 520 may be a 5GC 540. The 5GC 540 may include an AUSF 542, AMF 544, SMF 546, UPF 548, NSSF 550, NEF 552, NRF 554, PCF 556, UDM 558, and AF 560 coupled with one another over interfaces (or “reference points”) as shown. Functions of the elements of the 5GC 540 may be briefly introduced as follows.

The AUSF 542 may store data for authentication of UE 502 and handle authentication-related functionality. The AUSF 542 may facilitate a common authentication framework for various access types. In addition to communicating with other elements of the 5GC 540 over reference points as shown, the AUSF 542 may exhibit an Nausf service-based interface.

The AMF 544 may allow other functions of the 5GC 540 to communicate with the UE 502 and the RAN 504 and to subscribe to notifications about mobility events with respect to the UE 502. The AMF 544 may be responsible for registration management (for example, for registering UE 502), connection management, reachability management, mobility management, lawful interception of AMF-related events, and access authentication and authorization. The AMF 544 may provide transport for SM messages between the UE 502 and the SMF 546, and act as a transparent proxy for routing SM messages. AMF 544 may also provide transport for SMS messages between UE 502 and an SMSF. AMF 544 may interact with the AUSF 542 and the UE 502 to perform various security anchor and context management functions. Furthermore, AMF 544 may be a termination point of a RAN CP interface, which may include or be an N2 reference point between the RAN 504 and the AMF 544; and the AMF 544 may be a termination point of NAS (N1) signaling, and perform NAS ciphering and integrity protection. AMF 544 may also support NAS signaling with the UE 502 over an N3 IWF interface.

The SMF 546 may be responsible for SM (for example, session establishment, tunnel management between UPF 548 and AN 508); UE IP address allocation and management (including optional authorization); selection and control of UP function; configuring traffic steering at UPF 548 to route traffic to proper destination; termination of interfaces toward policy control functions; controlling part of policy enforcement, charging, and QoS; lawful intercept (for SM events and interface to L1 system); termination of SM parts of NAS messages; downlink data notification; initiating AN specific SM information, sent via AMF 544 over N2 to AN 508; and determining SSC mode of a session. SM may refer to management of a PDU session, and a PDU session or “session” may refer to a PDU connectivity service that provides or enables the exchange of PDUs between the UE 502 and the data network 536.

The UPF 548 may act as an anchor point for intra-RAT and inter-RAT mobility, an external PDU session point of interconnect to data network 536, and a branching point to support multi-homed PDU session. The UPF 548 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 548 may include an uplink classifier to support routing traffic flows to a data network.

The NSSF 550 may select a set of network slice instances serving the UE 502. The NSSF 550 may also determine allowed NSSAI and the mapping to the subscribed S-NSSAIs, if needed. The NSSF 550 may also determine the AMF set to be used to serve the UE 502, or a list of candidate AMFs based on a suitable configuration and possibly by querying the NRF 554. The selection of a set of network slice instances for the UE 502 may be triggered by the AMF 544 with which the UE 502 is registered by interacting with the NSSF 550, which may lead to a change of AMF. The NSSF 550 may interact with the AMF 544 via an N22 reference point; and may communicate with another NSSF in a visited network via an N31 reference point (not shown). Additionally, the NSSF 550 may exhibit an Nnssf service-based interface.

The NEF 552 may securely expose services and capabilities provided by 3GPP network functions for third party, internal exposure/re-exposure, AFs (e.g., AF 560), edge computing or fog computing systems, etc. In such embodiments, the NEF 552 may authenticate, authorize, or throttle the AFs. NEF 552 may also translate information exchanged with the AF 560 and information exchanged with internal network functions. For example, the NEF 552 may translate between an AF-Service-Identifier and an internal 5GC information. NEF 552 may also receive information from other NFs based on exposed capabilities of other NFs. This information may be stored at the NEF 552 as structured data, or at a data storage NF using standardized interfaces. The stored information can then be re-exposed by the NEF 552 to other NFs and AFs, or used for other purposes such as analytics. Additionally, the NEF 552 may exhibit an Nnef service-based interface.

The NRF 554 may support service discovery functions, receive NF discovery requests from NF instances, and provide the information of the discovered NF instances to the NF instances. NRF 554 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 554 may exhibit the Nnrf service-based interface.

The PCF 556 may provide policy rules to control plane functions to enforce them, and may also support unified policy framework to govern network behavior. The PCF 556 may also implement a front end to access subscription information relevant for policy decisions in a UDR of the UDM 558. In addition to communicating with functions over reference points as shown, the PCF 556 exhibit an Npcf service-based interface.

The UDM 558 may handle subscription-related information to support the network entities' handling of communication sessions, and may store subscription data of UE 502. For example, subscription data may be communicated via an N8 reference point between the UDM 558 and the AMF 544. The UDM 558 may include two parts, an application front end and a UDR. The UDR may store subscription data and policy data for the UDM 558 and the PCF 556, and/or structured data for exposure and application data (including PFDs for application detection, application request information for multiple UEs 502) for the NEF 552. The Nudr service-based interface may be exhibited by the UDR to allow the UDM 558, PCF 556, and NEF 552 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 558 may exhibit the Nudm service-based interface.

The AF 560 may provide application influence on traffic routing, provide access to NEF, and interact with the policy framework for policy control.

In some embodiments, the 5GC 540 may enable edge computing by selecting operator/3rd party services to be geographically close to a point that the UE 502 is attached to the network. This may reduce latency and load on the network. To provide edge-computing implementations, the 5GC 540 may select a UPF 548 close to the UE 502 and execute traffic steering from the UPF 548 to data network 536 via the N6 interface. This may be based on the UE subscription data, UE location, and information provided by the AF 560. In this way, the AF 560 may influence UPF (re) selection and traffic routing. Based on operator deployment, when AF 560 is considered to be a trusted entity, the network operator may permit AF 560 to interact directly with relevant NFs. Additionally, the AF 560 may exhibit an Naf service-based interface.

The data network 536 may represent various network operator services, Internet access, or third party services that may be provided by one or more servers including, for example, application/content server 538.

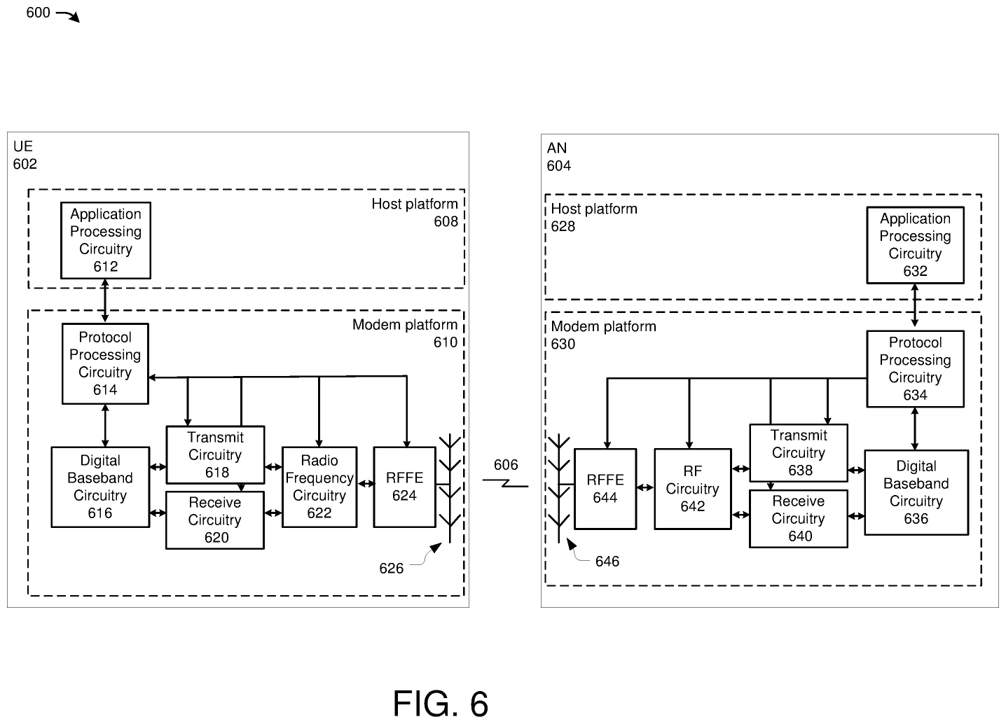

FIG. 6 schematically illustrates a wireless network 600 in accordance with various embodiments. The wireless network 600 may include a UE 602 in wireless communication with an AN 604. The UE 602 and AN 604 may be similar to, and substantially interchangeable with, like-named components described elsewhere herein.

The UE 602 may be communicatively coupled with the AN 604 via connection 606. The connection 606 is illustrated as an air interface to enable communicative coupling, and can be consistent with cellular communications protocols such as an LTE protocol or a 5G NR protocol operating at mmWave or sub-6 GHZ frequencies.

The UE 602 may include a host platform 608 coupled with a modem platform 610. The host platform 608 may include application processing circuitry 612, which may be coupled with protocol processing circuitry 614 of the modem platform 610. The application processing circuitry 612 may run various applications for the UE 602 that source/sink application data. The application processing circuitry 612 may further implement one or more layer operations to transmit/receive application data to/from a data network. These layer operations may include transport (for example UDP) and Internet (for example, IP) operations

The protocol processing circuitry 614 may implement one or more of layer operations to facilitate transmission or reception of data over the connection 606. The layer operations implemented by the protocol processing circuitry 614 may include, for example, MAC, RLC, PDCP, RRC and NAS operations.

The modem platform 610 may further include digital baseband circuitry 616 that may implement one or more layer operations that are “below” layer operations performed by the protocol processing circuitry 614 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 610 may further include transmit circuitry 618, receive circuitry 620, RF circuitry 622, and RF front end (RFFE) 624, which may include or connect to one or more antenna panels 626. Briefly, the transmit circuitry 618 may include a digital-to-analog converter, mixer, intermediate frequency (IF) components, etc.; the receive circuitry 620 may include an analog-to-digital converter, mixer, IF components, etc.; the RF circuitry 622 may include a low-noise amplifier, a power amplifier, power tracking components, etc.; RFFE 624 may include filters (for example, surface/bulk acoustic wave filters), switches, antenna tuners, beamforming components (for example, phase-array antenna components), etc. The selection and arrangement of the components of the transmit circuitry 618, receive circuitry 620, RF circuitry 622, RFFE 624, and antenna panels 626 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 614 may include one or more instances of control circuitry (not shown) to provide control functions for the transmit/receive components.

A UE reception may be established by and via the antenna panels 626, RFFE 624, RF circuitry 622, receive circuitry 620, digital baseband circuitry 616, and protocol processing circuitry 614. In some embodiments, the antenna panels 626 may receive a transmission from the AN 604 by receive-beamforming signals received by a plurality of antennas/antenna elements of the one or more antenna panels 626.

A UE transmission may be established by and via the protocol processing circuitry 614, digital baseband circuitry 616, transmit circuitry 618, RF circuitry 622, RFFE 624, and antenna panels 626. In some embodiments, the transmit components of the UE 604 may apply a spatial filter to the data to be transmitted to form a transmit beam emitted by the antenna elements of the antenna panels 626.

Similar to the UE 602, the AN 604 may include a host platform 628 coupled with a modem platform 630. The host platform 628 may include application processing circuitry 632 coupled with protocol processing circuitry 634 of the modem platform 630. The modem platform may further include digital baseband circuitry 636, transmit circuitry 638, receive circuitry 640, RF circuitry 642, RFFE circuitry 644, and antenna panels 646. The components of the AN 604 may be similar to and substantially interchangeable with like-named components of the UE 602. In addition to performing data transmission/reception as described above, the components of the AN 608 may perform various logical functions that include, for example, RNC functions such as radio bearer management, uplink and downlink dynamic radio resource management, and data packet scheduling.

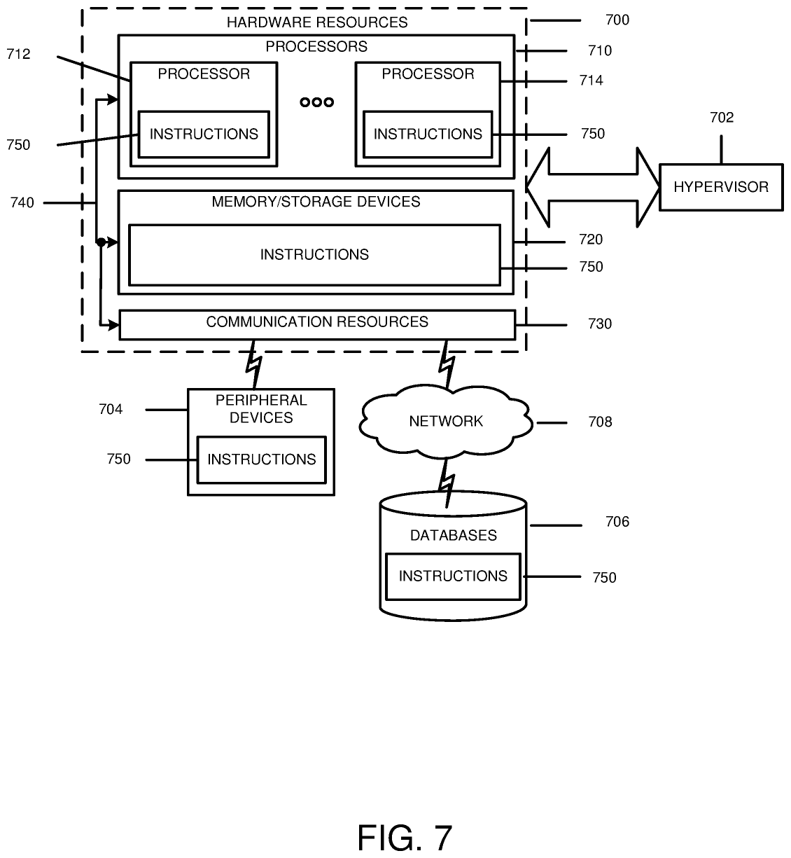

FIG. 7 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 7 shows a diagrammatic representation of hardware resources 700 including one or more processors (or processor cores) 710, one or more memory/storage devices 720, and one or more communication resources 730, each of which may be communicatively coupled via a bus 740 or other interface circuitry. For embodiments where node virtualization (e.g., NFV) is utilized, a hypervisor 702 may be executed to provide an execution environment for one or more network slices/sub-slices to utilize the hardware resources 700.

The processors 710 may include, for example, a processor 712 and a processor 714. The processors 710 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 720 may include main memory, disk storage, or any suitable combination thereof. The memory/storage devices 720 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 730 may include interconnection or network interface controllers, components, or other suitable devices to communicate with one or more peripheral devices 704 or one or more databases 706 or other network elements via a network 708. For example, the communication resources 730 may include wired communication components (e.g., for coupling via USB, Ethernet, etc.), cellular communication components, NFC components, Bluetooth® (or Bluetooth® Low Energy) components, Wi-Fi® components, and other communication components.

Instructions 750 may comprise software, a program, an application, an applet, an app, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources 700 from any combination of the peripheral devices 704 or the databases 706. Accordingly, the memory of processors 710, the memory/storage devices 720, the peripheral devices 704, and the databases 706 are examples of computer-readable and machine-readable media.

The following examples pertain to further embodiments.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit. As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Various embodiments are described below.

Example 1 may include an apparatus of a network device for quality of service (QOS)-level security configuration in a packet data unit (PDU) session, the apparatus comprising processing circuitry coupled to storage for storing information associated with the QoS-level security configuration, the processing circuitry configured to: identify a first user plane security indication received from an application function of a wireless network; identify a second user plane security indication received from the application function; generate, based on the first user plane security indication, a first security configuration for a first QoS flow of a PDU session between a user equipment device (UE) and the wireless network; generate, based on the second user plane security indication, a second security configuration for a second QoS flow of the PDU session, the first security configuration different than the second security configuration; decode a first packet received, from the UE, in the first QoS flow using the first security configuration; and decode a second packet received, from the UE, in the second QoS flow using the second security configuration.

Example 2 may include the apparatus of example 1 and/or any other example herein, wherein the processing circuitry is further configured to: generate, by a policy control function (PCF) of the wireless network, a first rule comprising an indication of the first user plane security indication; and generate, by the PCF, a second rule comprising an indication of the second user plane security indication, wherein the first security configuration is generated by a session management function (SMF) of the wireless network based on the first rule, and wherein the second security configuration is generated by the SMF based on the second rule.

Example 3 may include the apparatus of example 1 and/or any other example herein, wherein the first security configuration comprises at least one of a cipher or an integrity protocol being active, and wherein the second security configuration comprises the at least one of the cipher or the integrity protocol being inactive.

Example 4 may include the apparatus of example 1 and/or any other example herein, wherein the first user plane security indication comprises a first description of the first QoS flow, and wherein the second user plane security indication comprises a second description of the second QoS flow.

Example 5 may include the apparatus of example 1 and/or any other example herein, wherein the first user plane security indication and the second user plane security indication are received, from the application function, by a network exposure function (NEF) of the wireless network, and wherein the processing circuitry is further configured to: identify, by a PCF of the wireless network, the first user plane security indication and the second user plane security indication received from the NEF.

Example 6 may include the apparatus of example 1 and/or any other example herein, wherein the processing circuitry is further configured to: determine, by a SMF of the wireless network, based on the first user plane security indication, that the first QoS flow is to be generated; and determine, by the SMF, based on the second user plane security indication, the second QoS flow is to be generated.

Example 7 may include the apparatus of example 6 and/or any other example herein, wherein the processing circuitry is further configured to: identify, by a radio access network (RAN) of the wireless network, a first QoS flow setup request received from the SMF via an application management function (AMF) of the wireless network, the first QoS flow setup request comprising the first user plane security indication; and identify, by the RAN, a second QoS flow setup request received from the SMF via the AMF, the second QoS flow setup request comprising the second user plane security indication.

Example 8 may include the apparatus of example 7 and/or any other example herein, wherein the processing circuitry is further configured to: establish, by the RAN, a first radio bearer for the first QoS flow based on the first QOS flow setup request; and establish, by the RAN, a second radio bearer for the second QoS flow based on the second QoS flow setup request.

Example 9 may include a computer-readable storage medium comprising instructions to cause processing circuitry of a network device for quality of service (QOS)-level security configuration in a packet data unit (PDU) session, upon execution of the instructions by the processing circuitry, to: identify a first user plane security indication received from an application function of a wireless network; identify a second user plane security indication received from the application function; generate, based on the first user plane security indication, a first security configuration for a first QoS flow of a PDU session between a user equipment device (UE) and the wireless network; generate, based on the second user plane security indication, a second security configuration for a second QoS flow of the PDU session, the first security configuration different than the second security configuration; decode a first packet received, from the UE, in the first QoS flow using the first security configuration; and decode a second packet received, from the UE, in the second QoS flow using the second security configuration.

Example 10 may include the computer-readable medium of example 9 and/or any other example herein, wherein execution of the instructions further causes the processing circuitry to: generate, by a policy control function (PCF) of the wireless network, a first rule comprising an indication of the first user plane security indication; and generate, by the PCF, a second rule comprising an indication of the second user plane security indication, wherein the first security configuration is generated by a session management function (SMF) of the wireless network based on the first rule, and wherein the second security configuration is generated by the SMF based on the second rule.

Example 11 may include the computer-readable medium of example 9 and/or any other example herein, wherein the first security configuration comprises at least one of a cipher or an integrity protocol being active, and wherein the second security configuration comprises the at least one of the cipher or the integrity protocol being inactive.

Example 12 may include the computer-readable medium of example 9 and/or any other example herein, wherein the first user plane security indication comprises a first description of the first QoS flow, and wherein the second user plane security indication comprises a second description of the second QoS flow.

Example 13 may include the computer-readable medium of example 9 and/or any other example herein, wherein the first user plane security indication and the second user plane security indication are received, from the application function, by a network exposure function (NEF) of the wireless network, and wherein execution of the instructions further causes the processing circuitry to: identify, by a PCF of the wireless network, the first user plane security indication and the second user plane security indication received from the NEF.

Example 14 may include the computer-readable medium of example 9 and/or any other example herein, wherein execution of the instructions further causes the processing circuitry to: determine, by a SMF of the wireless network, based on the first user plane security indication, that the first QoS flow is to be generated; and determine, by the SMF, based on the second user plane security indication, the second QoS flow is to be generated.

Example 15 may include the computer-readable medium of example 14 and/or any other example herein, wherein execution of the instructions further causes the processing circuitry to: identify, by a radio access network (RAN) of the wireless network, a first QoS flow setup request received from the SMF via an application management function (AMF) of the wireless network, the first QoS flow setup request comprising the first user plane security indication; and identify, by the RAN, a second QoS flow setup request received from the SMF via the AMF, the second QoS flow setup request comprising the second user plane security indication.

Example 16 may include the computer-readable medium of example 15 and/or any other example herein, wherein execution of the instructions further causes the processing circuitry to: establish, by the RAN, a first radio bearer for the first QoS flow based on the first QoS flow setup request; and establish, by the RAN, a second radio bearer for the second QoS flow based on the second QoS flow setup request.

Example 17 may include a method for quality of service (QOS)-level security configuration in a packet data unit (PDU) session, the method comprising: identifying, by processing circuitry of a wireless network, a first user plane security indication received from an application function of a wireless network; identifying, by the processing circuitry, a second user plane security indication received from the application function; generating, by the processing circuitry, based on the first user plane security indication, a first security configuration for a first QoS flow of a PDU session between a user equipment device (UE) and the wireless network; generating, by the processing circuitry, based on the second user plane security indication, a second security configuration for a second QoS flow of the PDU session, the first security configuration different than the second security configuration; decoding, by the processing circuitry, a first packet received, from the UE, in the first QoS flow using the first security configuration; and decoding, by the processing circuitry, a second packet received, from the UE, in the second QoS flow using the second security configuration.

Example 18 may include the method of example 17 and/or any other example herein, further comprising: generating, by a policy control function (PCF) of the wireless network, a first rule comprising an indication of the first user plane security indication; and generating, by the PCF, a second rule comprising an indication of the second user plane security indication, wherein the first security configuration is generated by a session management function (SMF) of the wireless network based on the first rule, and wherein the second security configuration is generated by the SMF based on the second rule.

Example 19 may include the method of example 17 and/or any other example herein, wherein the first security configuration comprises at least one of a cipher or an integrity protocol being active, and wherein the second security configuration comprises the at least one of the cipher or the integrity protocol being inactive.

Example 20 may include the method of example 17 and/or any other example herein, wherein the first security configuration comprises at least one of a cipher or an integrity protocol being active, and wherein the second security configuration comprises the at least one of the cipher or the integrity protocol being inactive.

Example 21 may include the method of example 17 and/or any other example herein, wherein the first user plane security indication and the second user plane security indication are received, from the application function, by a network exposure function (NEF) of the wireless network, the method further comprising: identifying, by a PCF of the wireless network, the first user plane security indication and the second user plane security indication received from the NEF.

Example 22 may include the method of example 17 and/or any other example herein, further comprising: determining, by a SMF of the wireless network, based on the first user plane security indication, that the first QoS flow is to be generated; and determining, by the SMF, based on the second user plane security indication, the second QoS flow is to be generated.

Example 23 may include the method of example 22 and/or any other example herein, further comprising: identifying, by a radio access network (RAN) of the wireless network, a first QoS flow setup request received from the SMF via an application management function (AMF) of the wireless network, the first QoS flow setup request comprising the first user plane security indication; and identifying, by the RAN, a second QoS flow setup request received from the SMF via the AMF, the second QoS flow setup request comprising the second user plane security indication.

Example 24 may include an apparatus including means for: identifying, by a wireless network, a first user plane security indication received from an application function of a wireless network; identifying a second user plane security indication received from the application function; generating, based on the first user plane security indication, a first security configuration for a first QoS flow of a PDU session between a user equipment device (UE) and the wireless network; generating, based on the second user plane security indication, a second security configuration for a second QoS flow of the PDU session, the first security configuration different than the second security configuration; decoding a first packet received, from the UE, in the first QoS flow using the first security configuration; and decoding a second packet received, from the UE, in the second QoS flow using the second security configuration.

Example 25 may include one or more non-transitory computer-readable media comprising instructions to cause an electronic device, upon execution of the instructions by one or more processors of the electronic device, to perform one or more elements of a method described in or related to any of examples 1-24, or any other method or process described herein.

Example 26 may include an apparatus comprising logic, modules, and/or circuitry to perform one or more elements of a method described in or related to any of examples 1-24, or any other method or process described herein.

Example 27 may include a method, technique, or process as described in or related to any of examples 1-24, or portions or parts thereof.

Example 28 may include an apparatus comprising: one or more processors and one or more computer readable media comprising instructions that, when executed by the one or more processors, cause the one or more processors to perform the method, techniques, or process as described in or related to any of examples 1-24, or portions thereof.

Example 29 may include a method of communicating in a wireless network as shown and described herein.

Example 30 may include a system for providing wireless communication as shown and described herein.

Example 31 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

Unless used differently herein, terms, definitions, and abbreviations may be consistent with terms, definitions, and abbreviations defined in 3GPP TR 21.905 v16.0.0 (2019-06) and/or any other 3GPP standard. For the purposes of the present document, the following abbreviations (shown in Table 3) may apply to the examples and embodiments discussed herein.

TABLE 3
Abbreviations

3GPP Third Generation Partnership Project
4G Fourth Generation
5G Fifth Generation
5GC 5G Core network
AC Application Client
ACK Acknowledgement
ACID Application Client Identification
AF Application Function
AM Acknowledged Mode
AMBR Aggregate Maximum Bit Rate
AMF Access and Mobility Management Function
AN Access Network
ANR Automatic Neighbour Relation
AP Application Protocol, Antenna Port, Access Point
API Application Programming Interface
APN Access Point Name
ARP Allocation and Retention Priority
ARQ Automatic Repeat Request
AS Access Stratum
ASP Application Service Provider
ASN.1 Abstract Syntax Notation One
AUSF Authentication Server Function
AWGN Additive White Gaussian Noise
BAP Backhaul Adaptation Protocol
BCH Broadcast Channel
BER Bit Error Ratio
BFD Beam Failure Detection
BLER Block Error Rate
BPSK Binary Phase Shift Keying
BRAS Broadband Remote Access Server
BSS Business Support System
BS Base Station
BSR Buffer Status Report
BW Bandwidth
BWP Bandwidth Part
C-RNTI Cell Radio Network Temporary Identity
CA Carrier Aggregation, Certification Authority
CAPEX CAPital EXpenditure
CBRA Contention Based Random Access
CC Component Carrier, Country Code, Cryptographic Checksum
CCA Clear Channel Assessment
CCE Control Channel Element
CCCH Common Control Channel
CE Coverage Enhancement
CDM Content Delivery Network
CDMA Code-Division Multiple Access
CFRA Contention Free Random Access
CG Cell Group
CGF Charging Gateway Function
CHF Charging Function
CI Cell Identity
CID Cell-ID (e.g., positioning method)
CIM Common Information Model
CIR Carrier to Interference Ratio
CK Cipher Key
CM Connection Management, Conditional Mandatory
CMAS Commercial Mobile Alert Service
CMD Command
CMS Cloud Management System
CO Conditional Optional
CoMP Coordinated Multi-Point
CORESET Control Resource Set
COTS Commercial Off-The-Shelf
CP Control Plane, Cyclic Prefix, Connection Point
CPD Connection Point Descriptor
CPE Customer Premise Equipment
CPICH Common Pilot Channel
CQI Channel Quality Indicator
CPU CSI processing unit, Central Processing Unit
C/R Command/Response field bit
CRAN Cloud Radio Access Network, Cloud RAN
CRB Common Resource Block
CRC Cyclic Redundancy Check
CRI Channel-State Information Resource Indicator,
CSI-RS Resource Indicator
C-RNTI Cell RNTI
CS Circuit Switched
CSAR Cloud Service Archive
CSI Channel-State Information
CSI-IM CSI Interference Measurement
CSI-RS CSI Reference Signal
CSI-RSRP CSI reference signal received power
CSI-RSRQ CSI reference signal received quality
CSI-SINR CSI signal-to-noise and interference ratio
CSMA Carrier Sense Multiple Access
CSMA/CA CSMA with collision avoidance
CSS Common Search Space, Cell-specific Search Space
CTF Charging Trigger Function
CTS Clear-to-Send
CW Codeword
CWS Contention Window Size
D2D Device-to-Device
DC Dual Connectivity, Direct Current
DCI Downlink Control Information
DF Deployment Flavour
DL Downlink
DMTF Distributed Management Task Force
DPDK Data Plane Development Kit
DM-RS, DMRS Demodulation Reference Signal
DN Data network
DNN Data Network Name
DNAI Data Network Access Identifier
DRB Data Radio Bearer
DRS Discovery Reference Signal
DRX Discontinuous Reception
DSL Domain Specific Language. Digital Subscriber Line
DSLAM DSL Access Multiplexer
DwPTS Downlink Pilot Time Slot
E-LAN Ethernet Local Area Network
E2E End-to-End
ECCA extended clear channel assessment, extended CCA
ECCE Enhanced Control Channel Element, Enhanced CCE
ED Energy Detection
EDGE Enhanced Datarates for GSM Evolution (GSM Evolution)
EAS Edge Application Server
EASID Edge Application Server Identification
ECS Edge Configuration Server
ECSP Edge Computing Service Provider
EDN Edge Data Network
EEC Edge Enabler Client
EECID Edge Enabler Client Identification
EES Edge Enabler Server
EESID Edge Enabler Server Identification
EHE Edge Hosting Environment
EGMF Exposure Governance tableManagement Function
EGPRS Enhanced GPRS
EIR Equipment Identity Register
eLAA enhanced Licensed Assisted Access, enhanced LAA
EM Element Manager
eMBB Enhanced Mobile Broadband
EMS Element Management System
eNB evolved NodeB, E-UTRAN Node B
EN-DC E-UTRA-NR Dual Connectivity
EPC Evolved Packet Core
EPDCCH enhanced PDCCH, enhanced Physical Downlink Control Cannel
EPRE Energy per resource element
EPS Evolved Packet System
EREG enhanced REG, enhanced resource element groups
ETSI European Telecommunications Standards Institute
ETWS Earthquake and Tsunami Warning System
eUICC embedded UICC, embedded Universal Integrated Circuit Card
E-UTRA Evolved UTRA
E-UTRAN Evolved UTRAN
EV2X Enhanced V2X
F1AP F1 Application Protocol
F1-C F1 Control plane interface
F1-U F1 User plane interface
FACCH Fast Associated Control CHannel
FACCH/F Fast Associated Control Channel/Full rate
FACCH/H Fast Associated Control Channel/Half rate
FACH Forward Access Channel
FAUSCH Fast Uplink Signalling Channel
FB Functional Block
FBI Feedback Information
FCC Federal Communications Commission
FCCH Frequency Correction CHannel
FDD Frequency Division Duplex
FDM Frequency Division Multiplex
FDMA Frequency Division Multiple Access
FE Front End
FEC Forward Error Correction
FFS For Further Study
FFT Fast Fourier Transformation
feLAA further enhanced Licensed Assisted Access, further enhanced LAA
FN Frame Number
FPGA Field-Programmable Gate Array
FR Frequency Range
FQDN Fully Qualified Domain Name
G-RNTI GERAN Radio Network Temporary Identity
GERAN GSM EDGE RAN, GSM EDGE Radio Access Network
GGSN Gateway GPRS Support Node
GLONASS GLObal’naya NAvigatsionnaya Sputnikovaya Sistema
(Engl.: Global Navigation Satellite System)
gNB Next Generation NodeB
gNB-CUgNB-centralized unit, Next Generation NodeB centralized unit
gNB-DUgNB-distributed unit, Next Generation NodeB distributed unit
GNSS Global Navigation Satellite System
GPRS General Packet Radio Service
GPSI Generic Public Subscription Identifier
GSM Global System for Mobile Communications, Groupe Spécial Mobile
GTP GPRS Tunneling Protocol
GTP-U GPRS Tunnelling Protocol for User Plane
GTS Go To Sleep Signal (related to WUS)
GUMMEI Globally Unique MME Identifier
GUTI Globally Unique Temporary UE Identity
HARQ Hybrid ARQ, Hybrid Automatic Repeat Request
HANDO Handover
HFN HyperFrame Number
HHO Hard Handover
HLR Home Location Register
HN Home Network
HO Handover
HPLMN Home Public Land Mobile Network
HSDPA High Speed Downlink Packet Access
HSN Hopping Sequence Number
HSPA High Speed Packet Access
HSS Home Subscriber Server
HSUPA High Speed Uplink Packet Access
HTTP Hyper Text Transfer Protocol
HTTPS Hyper Text Transfer Protocol Secure
(https is http/1.1 over SSL, i.e. port 443)
I-Block Information Block
ICCID Integrated Circuit Card Identification
IAB Integrated Access and Backhaul
ICIC Inter-Cell Interference Coordination
ID Identity, identifier
IDFT Inverse Discrete Fourier Transform
IE Information element
IBE In-Band Emission
IEEE Institute of Electrical and Electronics Engineers
IEI Information Element Identifier
IEIDL Information Element Identifier Data Length
IETF Internet Engineering Task Force
IF Infrastructure
IM Interference Measurement, Intermodulation, IP Multimedia
IMC IMS Credentials
IMEI International Mobile Equipment Identity
IMGI International mobile group identity
IMPI IP Multimedia Private Identity
IMPU IP Multimedia PUblic identity
IMS IP Multimedia Subsystem
IMSI International Mobile Subscriber Identity
IoT Internet of Things
IP Internet Protocol
Ipsec IP Security, Internet Protocol Security
IP-CAN IP-Connectivity Access Network
IP-M IP Multicast
IPv4 Internet Protocol Version 4
IPv6 Internet Protocol Version 6
IR Infrared
IS In Sync
IRP Integration Reference Point
ISDN Integrated Services Digital Network
ISIM IM Services Identity Module
ISO International Organisation for Standardisation
ISP Internet Service Provider
IWF Interworking-Function
I-WLAN Interworking WLAN
Constraint length of the convolutional code, USIM Individual key
kB Kilobyte (1000 bytes)
kbps kilo-bits per second
Kc Ciphering key
Ki Individual subscriber authentication key
KPI Key Performance Indicator
KQI Key Quality Indicator
KSI Key Set Identifier
ksps kilo-symbols per second
KVM Kernel Virtual Machine
L1 Layer 1 (physical layer)
L1-RSRP Layer 1 reference signal received power
L2 Layer 2 (data link layer)
L3 Layer 3 (network layer)
LAA Licensed Assisted Access
LAN Local Area Network
LADN Local Area Data Network
LBT Listen Before Talk
LCM LifeCycle Management
LCR Low Chip Rate
LCS Location Services
LCID Logical Channel ID
LI Layer Indicator
LLC Logical Link Control, Low Layer Compatibility
LPLMN Local PLMN
LPP LTE Positioning Protocol
LSB Least Significant Bit
LTE Long Term Evolution
LWA LTE-WLAN aggregation
LWIP LTE/WLAN Radio Level Integration with IPsec Tunnel
LTE Long Term Evolution
M2M Machine-to-Machine
MAC Medium Access Control (protocol layering context)
MAC Message authentication code (security/encryption context)
MAC-A MAC used for authentication and key agreement
(TSG T WG3 context)
MAC-I MAC used for data integrity of signalling messages
(TSG T WG3 context)
MANO Management and Orchestration
MBMS Multimedia Broadcast and Multicast Service
MBSFN Multimedia Broadcast multicast service
Single Frequency Network
MCC Mobile Country Code
MCG Master Cell Group
MCOT Maximum Channel Occupancy Time
MCS Modulation and coding scheme
MDAF Management Data Analytics Function
MDAS Management Data Analytics Service
MDT Minimization of Drive Tests
ME Mobile Equipment
MeNB master eNB
MER Message Error Ratio
MGL Measurement Gap Length
MGRP Measurement Gap Repetition Period
MIB Master Information Block, Management Information Base
MIMO Multiple Input Multiple Output
MLC Mobile Location Centre
MM Mobility Management
MME Mobility Management Entity
MN Master Node
MNO Mobile Network Operator
MO Measurement Object, Mobile Originated
MPBCH MTC Physical Broadcast CHannel
MPDCCH MTC Physical Downlink Control CHannel
MPDSCH MTC Physical Downlink Shared CHannel
MPRACH MTC Physical Random Access CHannel
MPUSCH MTC Physical Uplink Shared Channel
MPLS MultiProtocol Label Switching
MS Mobile Station
MSB Most Significant Bit
MSC Mobile Switching Centre
MSI Minimum System Information,
MCH Scheduling Information
MSID Mobile Station Identifier
MSIN Mobile Station Identification Number
MSISDN Mobile Subscriber ISDN Number
MT Mobile Terminated, Mobile Termination
MTC Machine-Type Communications
mMTC massive MTC, massive Machine-Type Communications
MU-MIMO Multi User MIMO
MWUS MTC wake-up signal, MTC WUS
NACK Negative Acknowledgement
NAI Network Access Identifier
NAS Non-Access Stratum, Non-Access Stratum layer
NCT Network Connectivity Topology
NC-JT Non-Coherent Joint Transmission
NEC Network Capability Exposure
NE-DC NR-E-UTRA Dual Connectivity
NEF Network Exposure Function
NF Network Function
NFP Network Forwarding Path
NFPD Network Forwarding Path Descriptor
NFV Network Functions Virtualization
NFVI NFV Infrastructure
NFVO NFV Orchestrator
NG Next Generation, Next Gen
NGEN-DC NG-RAN E-UTRA-NR Dual Connectivity
NM Network Manager
NMS Network Management System
N-PoP Network Point of Presence
NMIB, N-MIB Narrowband MIB
NPBCH Narrowband Physical Broadcast CHannel
NPDCCH Narrowband Physical Downlink Control CHannel
NPDSCH Narrowband Physical Downlink Shared CHannel
NPRACH Narrowband Physical Random Access CHannel
NPUSCH Narrowband Physical Uplink Shared CHannel
NPSS Narrowband Primary Synchronization Signal
NSSS Narrowband Secondary Synchronization Signal
NR New Radio, Neighbour Relation
NRF NF Repository Function
NRS Narrowband Reference Signal
NS Network Service
NSA Non-Standalone operation mode
NSD Network Service Descriptor
NSR Network Service Record
NSSAI Network Slice Selection Assistance Information
S-NNSAI Single-NSSAI
NSSF Network Slice Selection Function
NW Network
NWUS Narrowband wake-up signal, Narrowband WUS
NZP Non-Zero Power
O&M Operation and Maintenance
ODU2 Optical channel Data Unit - type 2
OFDM Orthogonal Frequency Division Multiplexing
OFDMA Orthogonal Frequency Division Multiple Access
OOB Out-of-Band
OOS Out of Sync
OPEX OPerating EXpense
OSI Other System Information
OSS Operations Support System
OTA over-the-air
PAPR Peak-to-Average Power Ratio
PAR Peak to Average Ratio
PBCH Physical Broadcast Channel
PC Power Control, Personal Computer
PCC Primary Component Carrier, Primary CC
PCell Primary Cell
PCI Physical Cell ID, Physical Cell Identity
PCEF Policy and Charging Enforcement Function
PCF Policy Control Function
PCRFPolicy Control and Charging Rules Function
PDCP Packet Data Convergence Protocol,
Packet Data Convergence Protocol layer
PDCCH Physical Downlink Control Channel
PDCP Packet Data Convergence Protocol
PDN Packet Data Network, Public Data Network
PDSCH Physical Downlink Shared Channel
PDU Protocol Data Unit
PEI Permanent Equipment Identifiers
PFD Packet Flow Description
P-GW PDN Gateway
PHICH Physical hybrid-ARQ indicator channel
PHY Physical layer
PLMN Public Land Mobile Network
PIN Personal Identification Number
PM Performance Measurement
PMI Precoding Matrix Indicator
PNF Physical Network Function
PNFD Physical Network Function Descriptor
PNFR Physical Network Function Record
POC PTT over Cellular
PP, PTP Point-to-Point
PPP Point-to-Point Protocol
PRACH Physical RACH
PRB Physical resource block
PRG Physical resource block group
ProSe Proximity Services, Proximity-Based Service
PRS Positioning Reference Signal
PRR Packet Reception Radio
PS Packet Services
PSBCH Physical Sidelink Broadcast Channel
PSDCH Physical Sidelink Downlink Channel
PSCCH Physical Sidelink Control Channel
PSSCH Physical Sidelink Shared Channel
PSCell Primary SCell
PSS Primary Synchronization Signal
PSTN Public Switched Telephone Network
PT-RS Phase-tracking reference signal
PTT Push-to-Talk
PUCCH Physical Uplink Control Channel
PUSCH Physical Uplink Shared Channel
QAM Quadrature Amplitude Modulation
QCI QoS class of identifier
QCL Quasi co-location
QFI QoS Flow ID, QoS Flow Identifier
QoS Quality of Service
QPSK Quadrature (Quarternary) Phase Shift Keying
QZSS Quasi-Zenith Satellite System
RA-RNTI Random Access RNTI
RAB Radio Access Bearer, Random Access Burst
RACH Random Access Channel
RADIUS Remote Authentication Dial In User Service
RAN Radio Access Network
RAND RANDom number (used for authentication)
RAR Random Access Response
RAT Radio Access Technology
RAU Routing Area Update
RB Resource block, Radio Bearer
RBG Resource block group
REG Resource Element Group
Rel Release
REQ REQuest
RF Radio Frequency
RI Rank Indicator
RIV Resource indicator value
RL Radio Link
RLC Radio Link Control, Radio Link Control layer
RLC AM RLC Acknowledged Mode
RLC UM RLC Unacknowledged Mode
RLF Radio Link Failure
RLM Radio Link Monitoring
RLM-RS Reference Signal for RLM
RM Registration Management
RMC Reference Measurement Channel
RMSI Remaining MSI, Remaining Minimum System Information
RN Relay Node
RNC Radio Network Controller
RNL Radio Network Layer
RNTI Radio Network Temporary Identifier
ROHC RObust Header Compression
RRC Radio Resource Control, Radio Resource Control layer
RRM Radio Resource Management
RS Reference Signal
RSRP Reference Signal Received Power
RSRQ Reference Signal Received Quality
RSSI Received Signal Strength Indicator
RSU Road Side Unit
RSTD Reference Signal Time difference
RTP Real Time Protocol
RTS Ready-To-Send
RTT Round Trip Time
Rx Reception, Receiving, Receiver
S1AP S1 Application Protocol
S1-MMES1 for the control plane
S1-U S1 for the user plane
S-GW Serving Gateway
S-RNTI SRNC Radio Network Temporary Identity
S-TMSI SAE Temporary Mobile Station Identifier
SA Standalone operation mode
SAE System Architecture Evolution
SAP Service Access Point
SAPD Service Access Point Descriptor
SAPI Service Access Point Identifier
SCC Secondary Component Carrier, Secondary CC
SCell Secondary Cell
SCEF Service Capability Exposure Function
SC-FDMA Single Carrier Frequency Division Multiple Access
SCG Secondary Cell Group
SCM Security Context Management
SCS Subcarrier Spacing
SCTP Stream Control Transmission Protocol
SDAP Service Data Adaptation Protocol,
Service Data Adaptation Protocol layer
SDL Supplementary Downlink
SDNF Structured Data Storage Network Function
SDP Session Description Protocol
SDSF Structured Data Storage Function
SDU Service Data Unit
SEAF Security Anchor Function
SeNB secondary eNB
SEPP Security Edge Protection Proxy
SFI Slot format indication
SFTD Space-Frequency Time Diversity, SFN and frame timing difference
SFN System Frame Number
SgNB Secondary gNB
SGSN Serving GPRS Support Node
S-GW Serving Gateway
SI System Information
SI-RNTI System Information RNTI
SIB System Information Block
SIM Subscriber Identity Module
SIP Session Initiated Protocol
SiP System in Package
SL Sidelink
SLA Service Level Agreement
SM Session Management
SMF Session Management Function
SMS Short Message Service
SMSF SMS Function
SMTC SSB-based Measurement Timing Configuration
SN Secondary Node, Sequence Number
SoC System on Chip
SON Self-Organizing Network
SpCell Special Cell
SP-CSI-RNTI Semi-Persistent CSI RNTI
SPS Semi-Persistent Scheduling
SQN Sequence number
SR Scheduling Request
SRB Signalling Radio Bearer
SRS Sounding Reference Signal
SS Synchronization Signal
SSB Synchronization Signal Block
SSID Service Set Identifier
SS/PBCH Block
SSBRI SS/PBCH Block Resource Indicator,
Synchronization Signal Block Resource Indicator
SSC Session and Service Continuity
SS-RSRP Synchronization Signal based Reference Signal
Received Power
SS-RSRQ Synchronization Signal based Reference Signal
Received Quality
SS-SINR Synchronization Signal based Signal to Noise
and Interference Ratio
SSS Secondary Synchronization Signal
SSSG Search Space Set Group
SSSIF Search Space Set Indicator
SST Slice/Service Types
SU-MIMO Single User MIMO
SUL Supplementary Uplink
TA Timing Advance, Tracking Area
TAC Tracking Area Code
TAG Timing Advance Group
TAI Tracking Area Identity
TAU Tracking Area Update
TB Transport Block
TBS Transport Block Size
TBD To Be Defined
TCI Transmission Configuration Indicator
TCP Transmission Communication Protocol
TDD Time Division Duplex
TDM Time Division Multiplexing
TDMA Time Division Multiple Access
TE Terminal Equipment
TEID Tunnel End Point Identifier
TFT Traffic Flow Template
TMSI Temporary Mobile Subscriber Identity
TNL Transport Network Layer
TPC Transmit Power Control
TPMI Transmitted Precoding Matrix Indicator
TR Technical Report
TRP, TRxP Transmission Reception Point
TRS Tracking Reference Signal
TRx Transceiver
TS Technical Specifications, Technical Standard
TTI Transmission Time Interval
Tx Transmission, Transmitting, Transmitter
U-RNTI UTRAN Radio Network Temporary Identity
UART Universal Asynchronous Receiver and Transmitter
UCI Uplink Control Information
UE User Equipment
UDM Unified Data Management
UDP User Datagram Protocol
USDF Unstructured Data Storage Network Function
UICC Universal Integrated Circuit Card
UL Uplink
UM Unacknowledged Mode
UML Unified Modelling Language
UMTS Universal Mobile Telecommunications System
UP User Plane
UPF User Plane Function
URI Uniform Resource Identifier
URL Uniform Resource Locator
URLLC Ultra-Reliable and Low Latency
USB Universal Serial Bus
USIM Universal Subscriber Identity Module
USS UE-Specific search space
UTRA UMTS Terrestrial Radio Access
UTRAN Universal Terrestrial Radio Access Network
UwPTS Uplink Pilot Time Slot
V2I Vehicle-to-Infrastruction
V2P Vehicle-to-Pedestrian
V2V Vehicle-to-Vehicle
V2X Vehicle-to-everything
VIM Virtualized Infrastructure Manager
VL Virtual Link,
VLAN Virtual LAN, Virtual Local Area Network
VM Virtual Machine
VNF Virtualized Network Function
VNFFG VNF Forwarding Graph
VNFFGD VNF Forwarding Graph Descriptor
VNFM VNF Manager
VoIP Voice-over-IP, Voice-over-Internet Protocol
VPLMN Visited Public Land Mobile Network
VPN Virtual Private Network
VRB Virtual Resource Block
WiMAX Worldwide Interoperability for Microwave Access
WLAN Wireless Local Area Network
WMAN Wireless Metropolitan Area Network
WPAN Wireless Personal Area Network
X2-C X2-Control plane
X2-U X2-User plane
XML eXtensible Markup Language
XRES EXpected user RESponse
XOR eXclusive OR
ZC Zadoff-Chu
ZP Zero Po

What is claimed is:

1. An apparatus of a network device for quality of service (QOS)-level security configuration in a packet data unit (PDU) session, the apparatus comprising processing circuitry coupled to storage for storing information associated with the QoS-level security configuration, the processing circuitry configured to:
identify a first user plane security indication received from an application function of a wireless network;
identify a second user plane security indication received from the application function;
generate, based on the first user plane security indication, a first security configuration for a first QoS flow of a PDU session between a user equipment device (UE) and the wireless network;
generate, based on the second user plane security indication, a second security configuration for a second QoS flow of the PDU session, the first security configuration different than the second security configuration;
decode a first packet received, from the UE, in the first QoS flow using the first security configuration; and
decode a second packet received, from the UE, in the second QoS flow using the second security configuration.

2. The apparatus of claim 1, wherein the processing circuitry is further configured to:
generate, by a policy control function (PCF) of the wireless network, a first rule comprising an indication of the first user plane security indication; and
generate, by the PCF, a second rule comprising an indication of the second user plane security indication,
wherein the first security configuration is generated by a session management function (SMF) of the wireless network based on the first rule, and
wherein the second security configuration is generated by the SMF based on the second rule.

3. The apparatus of claim 1, wherein the first security configuration comprises at least one of a cipher or an integrity protocol being active, and wherein the second security configuration comprises the at least one of the cipher or the integrity protocol being inactive.

4. The apparatus of claim 1, wherein the first user plane security indication comprises a first description of the first QoS flow, and wherein the second user plane security indication comprises a second description of the second QoS flow.

5. The apparatus of claim 1, wherein the first user plane security indication and the second user plane security indication are received, from the application function, by a network exposure function (NEF) of the wireless network, and wherein the processing circuitry is further configured to:
identify, by a PCF of the wireless network, the first user plane security indication and the second user plane security indication received from the NEF.

6. The apparatus of claim 1, wherein the processing circuitry is further configured to:
determine, by a SMF of the wireless network, based on the first user plane security indication, that the first QoS flow is to be generated; and
determine, by the SMF, based on the second user plane security indication, the second QoS flow is to be generated.

7. The apparatus of claim 6, wherein the processing circuitry is further configured to:
identify, by a radio access network (RAN) of the wireless network, a first QoS flow setup request received from the SMF via an application management function (AMF) of the wireless network, the first QoS flow setup request comprising the first user plane security indication; and
identify, by the RAN, a second QoS flow setup request received from the SMF via the AMF, the second QoS flow setup request comprising the second user plane security indication.

8. The apparatus of claim 7, wherein the processing circuitry is further configured to:
establish, by the RAN, a first radio bearer for the first QoS flow based on the first QoS flow setup request; and
establish, by the RAN, a second radio bearer for the second QoS flow based on the second QoS flow setup request.

9. A non-transitory computer-readable storage medium comprising instructions to cause processing circuitry of a network device for quality of service (QOS)-level security configuration in a packet data unit (PDU) session, upon execution of the instructions by the processing circuitry, to:
identify a first user plane security indication received from an application function of a wireless network;
identify a second user plane security indication received from the application function; generate, based on the first user plane security indication, a first security configuration for a first QoS flow of a PDU session between a user equipment device (UE) and the wireless network;
generate, based on the second user plane security indication, a second security configuration for a second QoS flow of the PDU session, the first security configuration different than the second security configuration;
decode a first packet received, from the UE, in the first QoS flow using the first security configuration; and
decode a second packet received, from the UE, in the second QoS flow using the second security configuration.

10. The non-transitory computer-readable medium of claim 9, wherein execution of the instructions further causes the processing circuitry to:
generate, by a policy control function (PCF) of the wireless network, a first rule comprising an indication of the first user plane security indication; and
generate, by the PCF, a second rule comprising an indication of the second user plane security indication,
wherein the first security configuration is generated by a session management function (SMF) of the wireless network based on the first rule, and
wherein the second security configuration is generated by the SMF based on the second rule.

11. The non-transitory computer-readable medium of claim 9, wherein the first security configuration comprises at least one of a cipher or an integrity protocol being active, and wherein the second security configuration comprises the at least one of the cipher or the integrity protocol being inactive.

12. The non-transitory computer-readable medium of claim 9, wherein the first user plane security indication comprises a first description of the first QoS flow, and wherein the second user plane security indication comprises a second description of the second QoS flow.

13. The non-transitory computer-readable medium of claim 9, wherein the first user plane security indication and the second user plane security indication are received, from the application function, by a network exposure function (NEF) of the wireless network, and wherein execution of the instructions further causes the processing circuitry to:
identify, by a PCF of the wireless network, the first user plane security indication and the second user plane security indication received from the NEF.

14. The non-transitory computer-readable medium of claim 9, wherein execution of the instructions further causes the processing circuitry to:
determine, by a SMF of the wireless network, based on the first user plane security indication, that the first QoS flow is to be generated; and
determine, by the SMF, based on the second user plane security indication, the second QoS flow is to be generated.

15. The non-transitory computer-readable medium of claim 14, wherein execution of the instructions further causes the processing circuitry to:
identify, by a radio access network (RAN) of the wireless network, a first QoS flow setup request received from the SMF via an application management function (AMF) of the wireless network, the first QoS flow setup request comprising the first user plane security indication; and
identify, by the RAN, a second QoS flow setup request received from the SMF via the AMF, the second QoS flow setup request comprising the second user plane security indication

16. The non-transitory computer-readable medium of claim 15, wherein execution of the instructions further causes the processing circuitry to:
establish, by the RAN, a first radio bearer for the first QoS flow based on the first QoS flow setup request; and
establish, by the RAN, a second radio bearer for the second QoS flow based on the second QoS flow setup request.

17. A method for quality of service (QOS)-level security configuration in a packet data unit (PDU) session, the method comprising:
identifying, by processing circuitry of a wireless network, a first user plane security indication received from an application function of a wireless network;
identifying, by the processing circuitry, a second user plane security indication received from the application function;
generating, by the processing circuitry, based on the first user plane security indication, a first security configuration for a first QoS flow of a PDU session between a user equipment device (UE) and the wireless network;
generating, by the processing circuitry, based on the second user plane security indication, a second security configuration for a second QoS flow of the PDU session, the first security configuration different than the second security configuration;
decoding, by the processing circuitry, a first packet received, from the UE, in the first QoS flow using the first security configuration; and
decoding, by the processing circuitry, a second packet received, from the UE, in the second QoS flow using the second security configuration.

18. The method of claim 17, further comprising:
generating, by a policy control function (PCF) of the wireless network, a first rule comprising an indication of the first user plane security indication; and
generating, by the PCF, a second rule comprising an indication of the second user plane security indication,
wherein the first security configuration is generated by a session management function (SMF) of the wireless network based on the first rule, and
wherein the second security configuration is generated by the SMF based on the second rule.

19. A non-transitory computer-readable storage medium comprising instructions to perform the method of claim 17.

20. An apparatus comprising means for performing the method of claim 17.
